(19) United States
(12) Patent Application Publication
(10) Pub. No.: US 2010/0238321 A1
(43) Pub. Date: Sep. 23, 2010

(54) CAMERA BODY, INTERCHANGEABLE LENS UNIT, AND CAMERA SYSTEM

(75) Inventors: Kenichi Honjo, Osaka (JP); Hiroshi Ueda, Osaka (JP); Naoto Yumiki, Osaka (JP); Norikazu Katsuyama, Osaka (JP)

Correspondence Address: PANASONIC PATENT CENTER, 1130 CONNECTICUT AVENUE NW, SUITE 1100, WASHINGTON, DC, 20036, US

(73) Assignee: PANASONIC CORPORATION, Osaka (JP)

(21) Appl. No.: 12/679,509

(22) PCT Filed: Sep. 26, 2008
(86) PCT No.: PCT/JP2008/002692

§ 371 Date: Mar. 23, 2010

(30) Foreign Application Priority Data
Sep. 28, 2007 (JP) 2007-254043
Dec. 28, 2007 (JP) 2007-339172

(51) Int. Cl. H04N 5/76; H04N 5/225; H04N 5/232; H04N 5/222; H04N 5/262

(52) U.S. Cl. 348/231.99; 348/360; 348/345; 348/333.01; 348/240.2; 348/E05.024; 348/E05.045; 348/E05.022; 348/E05.055

(57) ABSTRACT

A camera body 3 includes a cross control key 27 and a body microcomputer 10. The body microcomputer 10 can acquire lens information related to an interchangeable lens unit 2 from the interchangeable lens unit 2. The body microcomputer 10 decides whether or not the interchangeable lens unit 2 is compatible with electric zoom on the basis of lens information. The body microcomputer 10 also activates zoom operation at the cross control key 27 on the basis of this decision result.

### TECHNICAL FIELD

The present invention relates to an interchangeable lens type of camera body, to an interchangeable lens unit, and to a camera system.

### BACKGROUND ART

Digital cameras with interchangeable lenses have surged in popularity in recent years. With these digital cameras, when the user looks at a subject through a viewfinder, the optical path of light that is incident on an imaging lens (that is, the subject image) is changed by a reflecting mirror disposed along the imaging optical path beyond the lens, and the light goes through a pentaprism, etc., and is converted into an erect image, and then is guided to an optical viewfinder. This allows the user to see the subject image that has passed through the lens through the optical viewfinder. Therefore, the position at which the viewfinder optical path is formed is usually the home position of the reflecting mirror.

On the other hand, when a lens is used for imaging, the reflecting mirror instantly changes its position and is retracted from the imaging optical path, which switches the viewfinder optical path to the imaging optical path, and the reflecting mirror instantly returns to its home position upon completion of the imaging. This system is the same for both conventional silver halide cameras and digital cameras, if they are single lens reflex types.

A feature of a digital camera is that an image is captured while the user looks at a display device (such as a liquid crystal monitor), and the captured image can be checked right after it is captured.

However, when a conventional single lens reflex reflecting mirror is used, a liquid crystal monitor cannot be used during imaging. Since imaging cannot be performed by using a liquid crystal monitor, the user has to look through the viewfinder during imaging, so conventional camera systems have been extremely difficult to use, especially for novices who are inexperienced in using digital cameras.

In view of this, there has been a proposal for a digital single lens reflex camera with which imaging can be performed while looking at a liquid crystal monitor (see Patent Citation 1, for example).

Patent Citation 1: Japanese Laid-Open Patent Application 2001-125173

Patent Citation 2: Japanese Laid-Open Patent Application 2005-311695

Patent Citation 3: Japanese Laid-Open Patent Application H1-108514

### DISCLOSURE OF INVENTION

However, a conventional interchangeable lens unit employs a zoom mechanism that mechanically drives the optical system. The user's operating force transmitted to a zoom ring is converted by this zoom mechanism into drive force for moving the optical system.

Meanwhile, an electric zoom type of interchangeable lens unit has been proposed in which the optical system is driven by a motor or other such electric actuator. With this interchangeable lens unit, the optical system is driven by the motor and the focal length (hereinafter also referred to as the zoom ratio) is adjusted according to how much the zoom ring or other zoom operation unit is operated.

Also, not only a still picture imaging function, but also a moving picture imaging function will be desired in future interchangeable lens type digital cameras (see Patent Citation 2, for example). With an interchangeable lens unit that is compatible with a moving picture imaging function, a focus lens group is driven by a motor, for example. With the interchangeable lens unit in Patent Citation 3, the user can switch between autofocus and electric manual focus.

Thus, interchangeable lens units in which the optical system is driven by an electric actuator have been proposed in the past.

Nevertheless, a camera body may not be compatible with an interchangeable lens unit in which the optical system is driven by motor. If the camera body is not compatible, there is the risk of system mismatching between the camera body and the interchangeable lens unit, but Patent Citations 1 to 3 disclose no teachings with which this problem can be solved.

It is an object of the present invention to provide a camera body and camera system with which compatibility with more interchangeable lens units can be ensured.

It is another object of the present invention to provide an interchangeable lens unit with which compatibility with more camera bodies can be ensured.

A camera body according to the present invention allows the mounting of an interchangeable lens unit having an optical system for forming an optical image of a subject. This camera body comprises a body operation interface, an information acquisition section, a decision section, and an operation setting section. The body operation interface is a unit with which the user can input operation information. The information acquisition section allows lens information related to the interchangeable lens unit to be acquired from the interchangeable lens unit. The decision section decides whether or not the optical system can be driven electrically in the optical axis direction, on the basis of lens information. The operation setting section activates lens drive operation for driving the optical system at the body operation interface, on the basis of the decision result of the decision section.

With this camera body, lens information is acquired by the information acquisition section from an interchangeable lens unit. The decision section decides whether or not the optical system can be driven electrically in the optical axis direction, on the basis of the acquired lens information. The operation setting section activates lens drive operation for driving the optical system at the body operation interface, on the basis of the decision result of the decision section. Accordingly, if the optical system can be driven electrically in the optical axis direction, for example, the drive of the optical system can be operated with the body operation interface. Consequently, a camera body will be compatible with an interchangeable lens unit with which the optical system can be driven electrically in the optical axis direction, so compatibility with more interchangeable lens units can be ensured. Also, with a camera system having this camera body, compatibility with more interchangeable lens unit can be ensured.

The phrase “the optical system can be driven electrically in the optical axis direction” here means, for example, that lens elements included in the optical system can be driven in the optical axis direction by an electric actuator. The phrase “the operation setting section activates lens drive operation” means that the optical system can be driven according to lens drive operation. Lens drive operation includes zoom operation for changing the focal length, and focus operation for changing the subject distance (the object distance of the subject when in focus).

An interchangeable lens unit according to the present invention comprises an optical system and a memory unit. The memory unit stores lens information. The lens information includes information related to whether or not the optical system can be electrically driven in the optical axis direction.

With this interchangeable lens unit, the lens information includes information related to whether or not the optical system can be electrically driven in the optical axis direction, and this lens information is stored in the memory unit. Accordingly, the camera body can decide whether or not to operate the drive of the optical system on the camera body side on the basis of lens information, and this ensures compatibility with more camera bodies.

### BRIEF DESCRIPTION OF DRAWINGS

FIG. 1 is a block diagram of a camera system when a zoom lever is installed in the interchangeable lens unit;

FIG. 2 is a block diagram of a camera body;

FIG. 3A is a simplified diagram of a camera body; and FIG. 3B is a simplified diagram of a camera body;

FIG. 4 is a diagram illustrating viewfinder imaging mode;

FIG. 5 is a diagram illustrating monitor imaging mode;

FIG. 6 is a flowchart of zoom operation selection processing;

FIG. 7A is a display example of a display unit when zoom operation is possible at the camera body, and FIG. 7B is a display example of a display unit when zoom operation is not possible;

FIG. 8 is a flowchart of electronic zoom operation selection processing;

FIG. 9A is a display example of a display unit when electronic zoom operation is possible, and FIG. 9B is a display example of a display unit when electronic zoom operation is not possible;

FIG. 10 is a flowchart of zoom operation unit priority processing (cross control key priority);

FIG. 11 is a flowchart of zoom operation priority processing (zoom lever priority);

FIG. 12 is a simplified oblique view of a camera system when a zoom lever is installed in the interchangeable lens unit;

FIG. 13 is a flowchart of focus operation selection processing;

FIG. 14A is a display example of a display unit when focus operation is possible at the camera body, and FIG. 14B is a display example of a display unit when focus operation is not possible at the camera body;

FIG. 15 is a flowchart of focus operation unit selection processing;

FIG. 16 is a flowchart of focus operation unit priority processing (cross control key priority);

FIG. 17 is a flowchart of focus operation unit priority processing (focus ring priority)

FIG. 18 is a block diagram of a camera system when a quick return mirror is not installed;

FIG. 19 is a simplified oblique view of a camera system when the zoom operation unit is a zoom ring;

FIG. 20 is a block diagram of a camera system when the zoom operation unit is a zoom ring;

FIG. 21 is a block diagram of a camera system when a quick return mirror is not installed and when the zoom operation unit is a zoom ring;

FIG. 22 is a simplified oblique view of a camera system when the focus operation unit is a focus lever; and

FIG. 23 is a block diagram of a camera system when the focus operation unit is a focus lever.

### EXPLANATION OF REFERENCE

1 camera system
2 interchangeable lens unit
3 camera body
3a case
4 body mount
10 body microcomputer (an example of an information acquisition section, an example of a decision section, and an example of an operation setting section)
11 imaging sensor (an example of an image acquisition section)
12 imaging sensor drive controller
15 digital signal processor (an example of an electronic zoom section)
20 display unit
21 image display controller (an example of a display controller)
23 quick return mirror
25 power switch
26 mode switching dial
27 cross control key (an example of a body operation interface, an example of an electric zoom operation unit, and an example of a focus operation unit)
28 menu setting button
29 set button
30 release button
31 shutter controller
33 shutter unit
34 viewfinder switching button
35 moving picture imaging button
40 lens microcomputer
41 focus lens drive controller
44 memory (an example of a memory unit)
61 zoom lens group drive controller
64 zoom operation lever (an example of a lens operation unit)
65 zoom operation detector
67 focus ring (an example of a lens operation unit)
68 rotation detector
79 lens mount
95 electronic viewfinder
L optical system
L1 first lens group
L2 second lens group

### BEST MODE FOR CARRYING OUT THE INVENTION

An embodiment of the present invention will now be described in detail through reference to the drawings.

### First Embodiment

### 1: Overall Configuration of Camera System

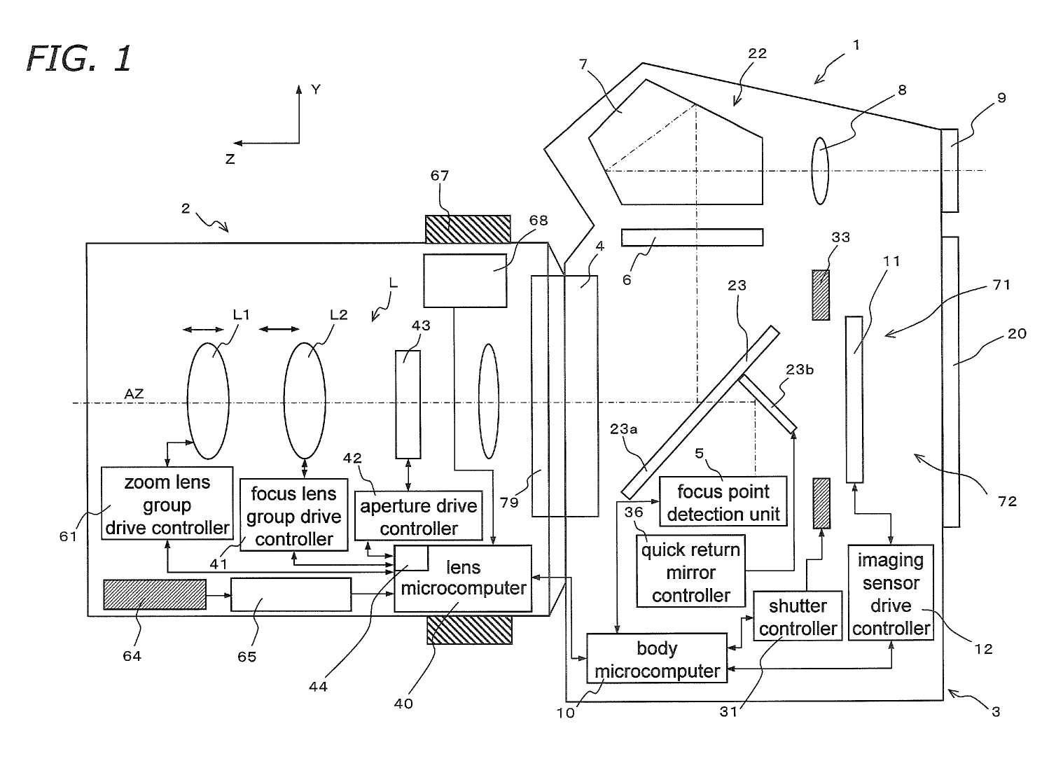

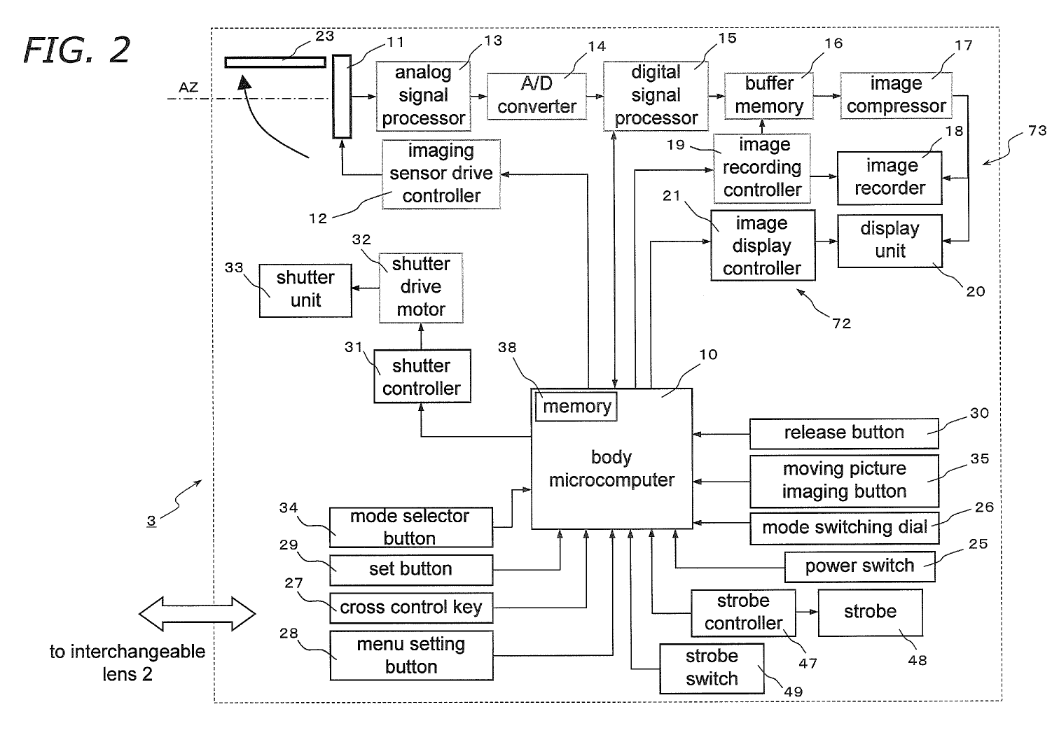

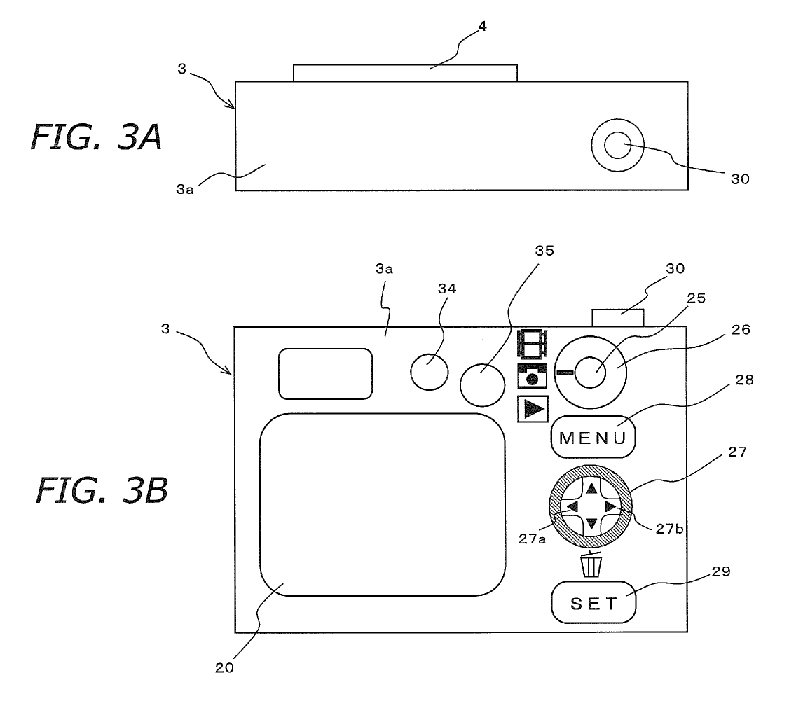

The overall configuration of the camera system 1 according to a first embodiment will be described through reference to FIGS. 1 to 3. FIG. 1 is a block diagram of the camera system 1. FIG. 2 is a block diagram of a camera body 3. FIGS. 3A and 3B are simplified diagrams the camera body 3, with FIG. 3A being a view of the camera body 3 from above, and FIG. 3B a view of the camera body 3 from the rear.

As shown in FIG. 1, the camera system 1 is an interchangeable lens type of digital single lens reflex camera system, and is made up mainly of the camera body 3 having the primary function of the digital camera 1, and an interchangeable lens unit 2 that is removably mounted to the camera body 3. The interchangeable lens unit 2 is mounted to a body mount 4 provided to the front face of the camera body 3, via a lens mount 79.

1.1: Interchangeable Lens Unit

As shown in FIGS. 1 and 2, the camera body 3 is made up mainly of an imaging unit 71 that captures an image of a subject, a body microcomputer 10 serving as a body controller for controlling the operation of the various components such as the imaging unit 71 (an example of an information acquisition section, an example of a decision section, and an example of an operation setting section), an image display unit 72 for displaying the captured image and various kinds of information, an image holder 73 for holding image data, and a viewfinder optical system 22 through which the subject image can be seen.

The imaging unit 71 mainly comprises a quick return mirror 23 for guiding incident light to the viewfinder optical system 22 and a focus point detection unit 5, an imaging sensor 11 such as a CCD (charge coupled device) for performing opto-electric conversion, a shutter unit 33 for adjusting the exposure state of the imaging sensor 11, a shutter controller 31 for controlling the drive of the shutter unit 33 on the basis of a control signal from the body microcomputer 10, an imaging sensor drive controller 12 for controlling the operation of the imaging sensor 11, and the focus point detection unit 5 for detecting the focus point (the focus state of the subject image). The focus point detection unit 5 performs focus detection by an ordinary phase difference detection method, for example. As to the focus detection method, either phase difference detection, in which the above-mentioned focus point detection unit 5 is used, or contrast detection, which is based on an image signal outputted from the imaging sensor 11, can be used depending on the usage state of the camera system 1. In the case of contrast detection, an evaluation is made and the focus point detected by the body microcomputer 10. Specifically, the body microcomputer 10 can be said to include a contrast detector. This focus point detection result is sent to a lens microcomputer 40 (discussed below) and used for the drive of the focus lens group (second lens group L2).

The imaging sensor 11 is, for example, a CCD (charge coupled device) sensor that converts the optical image formed by an imaging optical system L into an electrical signal. The drive of the imaging sensor 11 is controlled by a timing signal generated by the imaging sensor drive controller 12. The imaging sensor 11 may instead be a CMOS (complementary metal oxide semiconductor) sensor.

The body microcomputer 10 is a control device serving as the functional center of the camera body 3, and controls various sequences. More specifically, the body microcomputer 10 is equipped with a CPU, ROM, and RAM, and the body microcomputer 10 can perform many different functions when programs held in the ROM are read into the CPU. For instance, the body microcomputer 10 has the function of detecting that the interchangeable lens unit 2 has been mounted on the camera body 3, the function of acquiring information essential to the control of the camera system 1, such as information about the focal length from the interchangeable lens unit 2, and controlling the operation of the interchangeable lens unit 2, and so on. The body microcomputer 10 further has the function of acquiring from the interchangeable lens unit 2 information related to whether or not the interchangeable lens unit 2 is compatible with electric zoom, and information related to whether or not the interchangeable lens unit 2 has a zoom operation lever 64 (that is, it function as an information acquisition section). Also, the body microcomputer 10 has the function of acquiring from the interchangeable lens unit 2 information related to whether or not the interchangeable lens unit 2 is compatible with electric manual focus, and information related to whether or not the interchangeable lens unit 2 has a focus ring 67 (that is, it functions as an information acquisition section).

The body microcomputer 10 may also have the function of deciding whether or not the interchangeable lens unit 2 is compatible with moving picture imaging, and the function of setting the operation of the imaging sensor 11 to still or moving picture imaging mode via the imaging sensor drive controller 12. As shown in FIG. 1, the body microcomputer 10 is connected to the various components provided to the camera main body 3.

Also, the body microcomputer 10 can receive signals from the power switch 25, the release button 30, the mode switching dial 26, the cross control key 27 (an example of a body operation interface), the menu setting button 28, the set button 29, the viewfinder switching button 34, and the moving picture imaging button 35 shown in FIG. 3B.

Furthermore, as shown in FIG. 2, a memory 38 in the body microcomputer 10 holds various kinds of information related to the camera body 3 (body information). This body information includes, for example, information related to the model, for identifying the camera body 3, such as the name of the manufacturer of the camera body 3, the date of manufacture, the model number, the version of software installed in the body microcomputer 10, and information related to firmware updates. Further, the memory 38 can store information sent from the lens microcomputer 40.

The body microcomputer 10 controls the entire camera system according to operation of the release button 30 and so forth. The body microcomputer 10 sends a vertical synchronization signal to a timing generator. In parallel with this, the body microcomputer 10 generates an exposure synchronization signal on the basis of the vertical synchronization signal. The body microcomputer 10 repeatedly and periodically sends the generated exposure synchronization signal through the body mount 4 and the lens mount 79 to the lens microcomputer 40.

Also, the body microcomputer 10 can assign a zoom operation function to the cross control key 27 (discussed below), or send a zoom operation signal based on the operation of the cross control key 27 through the body mount 4 and the lens mount 79 to the lens microcomputer 40. If the lens microcomputer 40 sends a command to a zoom lens group drive controller 61 on the basis of a zoom operation signal, the zoom lens group L1 of the interchangeable lens unit 2 moves to the telephoto or wide angle side. Assignment of a zoom operation function to the cross control key 27 is automatically performed by the body microcomputer 10 (discussed below).

The assignment of a zoom operation function to the cross control key 27 may also be switched between active and inactive by operating the cross control key 27, the menu setting button 28, and the set button 29.

When a zoom operation function is assigned to the cross control key 27, if a left operation unit 27a of the cross control key 27 in FIG. 3B is operated, then the body microcomputer 10 sends a zoom operation signal through the body mount 4 and the lens mount 79 to the lens microcomputer 40 on the basis of this operation. When the lens microcomputer 40 sends a command to the zoom lens group drive controller 61 on the basis of this zoom operation signal, the zoom lens group L1 of the interchangeable lens unit 2 moves to the telephoto side.

On the other hand, if a right operation unit 27b of the cross control key 27 in FIG. 3B is operated, a zoom operation signal is sent through the body mount 4 and the lens mount 79 to the lens microcomputer 40 on the basis of this operation. When the lens microcomputer 40 sends a command to the zoom lens group drive controller 61 on the basis of this zoom operation signal, the zoom lens group L1 of the interchangeable lens unit 2 moves to the wide angle side.

The body mount 4 can be mechanically and electrically connected to the lens mount 79 of the interchangeable lens unit 2. The body mount 4 is able to exchange data with the interchangeable lens unit 2 via the lens mount 79. For example, the body mount 4 may send an exposure synchronization signal received from the body microcomputer 10 to the lens microcomputer 40 via the lens mount 79. Also, the body mount 4 may send other control signals received from the body microcomputer 10 to the lens microcomputer 40 via the lens mount 79. The body mount 4 may also send the body microcomputer 10 a signal received from the lens microcomputer 40 via the lens mount 79. The power supplied from a power supply unit (not shown) is supplied through the lens mount 79 to the entire interchangeable lens unit 2.

As shown in FIGS. 3A and 3B, the case 3a of the camera body 3 is held by the user during the imaging of a subject. On the rear face of the case 3a are provided a display unit 20, the power switch 25, the mode switching dial 26, the cross key 27, the menu setting button 28, the set button 29, the viewfinder switching button 34, and the moving picture imaging button 35.

The power switch 25 is used to turn on and off the power to the camera system 1 or the camera body 3. When the power has been turned on with the power switch 25, power is supplied to the various components of the camera body 3 and the interchangeable lens unit 2. The mode switching dial 26 is used to switch between still picture mode, moving picture mode, and reproduction mode, and the user can turn the mode switching dial 26 to switch the mode. When the still picture mode has been selected with the mode switching dial 26, the imaging mode can be switched to the still picture mode, and when the moving picture mode has been selected with the mode switching dial 26, the imaging mode can be switched to the moving picture mode. In moving picture mode, basically moving picture imaging is possible. Further, when reproduction mode has been selected with the mode switching dial 26, the mode can be switched to reproduction mode, and a moving picture image can be displayed on the display unit 20.

The menu setting button 28 is used to set the various operations of the camera system 1. The cross key 27 is pressed at the top, bottom, left, or right by the user to select the desired menu from various menus screens displayed on the display unit 20. The set button 29 is used to execute the various menu commands. The viewfinder switching button 34 switches between viewfinder imaging mode and monitor imaging mode (the viewfinder imaging mode and monitor imaging mode will be discussed below). The moving picture imaging button 35 is used to start or stop moving picture imaging, and even if the imaging mode set with the mode switching dial 26 is the still picture mode or the reproduction mode, when this moving picture imaging button 35 is pressed, the moving picture mode is forcibly commenced regardless of the setting on the mode switching dial 26. Furthermore, in moving picture mode, pressing the moving picture imaging button 35 ends moving picture imaging and switches to still picture mode or reproduction mode.

As shown in FIG. 3B, the release button 30 is provided to the upper face of the case 3a. When the release button 30 is pressed, a timing signal is outputted to the body microcomputer 10. The release button 30 is a two-stage switch that can be pressed halfway down or all the way down, and when the user presses the release button 30 halfway down, light metering and range finding are commenced. Also, when the button is pressed halfway down, power is supplied to the various components, including the body microcomputer 10 and the lens microcomputer 40. When the user then presses the release button 30 all the way down, a timing signal is outputted to the body microcomputer 10. The shutter controller 31 drives a shutter driver motor 32 and operates the shutter unit 33 according to the control signal outputted from the body microcomputer 10 upon receipt of the timing signal.

As shown in FIG. 2, in still picture mode, the body microcomputer 10 that has received a timing signal upon the pressing of the release button 30 outputs a control signal to a strobe controller 47. The strobe controller 47 flashes a strobe 48 including an LED or the like on the basis of the control signal. The strobe 48 is controlled according to the amount of light received by the imaging sensor 11. Specifically, the strobe controller 47 automatically flashes in conjunction with the shutter operation when the output of an image signal from the imaging sensor 11 is at or below a specific value. On the other hand, the strobe controller 47 is controlled so that it does not flash the strobe 48 when the output of the image signal is above a specific value.

A strobe switch 49 is used to set the operation of the strobe 48 regardless of the output of the imaging sensor 11. Specifically, the strobe controller 47 flashes the strobe 48 when the strobe switch 49 is “on,” and does not flash the strobe 48 when the strobe 48 is “off.”

In moving picture mode, when the release button 30 or the moving picture imaging button 35 is pressed, the strobe 48 (comprising an LED or the like) functions as a video light, which shines light toward the subject during moving picture imaging.

The image signal outputted from the imaging sensor 11 (a still or moving picture) is sent for processing from an analog signal processor 13 to an A/D converter 14, a digital signal processor 15 (an example of an electronic zoom section), a buffer memory 16, and an image compressor 17, in that order. The analog signal processor 13 performs gamma processing or other such analog signal processing on the image signal outputted from the imaging sensor 11. The A/D converter 14 converts the analog signal outputted from the analog signal processor 13 into a digital signal. The digital signal processor 15 subjects the image signal converted into a digital signal by the A/D converter 14 to digital signal processing, such as noise elimination or contour enhancement. The buffer memory 16 is a RAM, which temporarily stores image signals.

The image signal stored in the buffer memory 16 is sent from the image compressor 17 to an image recorder 18 for processing. The image signal stored in the buffer memory 16 is read at a command from an image recording controller 19 and sent to the image compressor 17. The image signal data sent to the image compressor 17 is compressed according to a command from the image recording controller 19. This compression reduces the image signal to a smaller data size than that of the original data. The compression method can be, for example, JPEG (Joint Photographic Experts Group) in the case of a still picture. In the case of a moving picture, MPEG (Moving Picture Experts Group) is used. Also, an H.264/AVC format in which a plurality of frames of image signals are compressed together can be used. The compressed image signal is recorded to the image recorder 18 by the image recording controller 19.

The digital signal processor 15 also has an electronic zoom function. More specifically, the digital signal processor 15 stores an image signal, part of which has been cropped near the center of the imaging sensor 11, in the buffer memory 16 at a command from the body microcomputer 10. In a situation in which a zoom operation function has been assigned to the cross control key 27, an electronic zoom function is realized by changing the surface area of the cropped region of the imaging sensor 11 according to the zoom ratio by pressing the cross control key 27. When the zoom ratio is changed to the telephoto side by operation of the cross control key 27, the digital signal processor 15 reduces the surface area of the cropped region of the imaging sensor 11, and when the zoom ratio is changed to the wide angle side, the digital signal processor 15 increases the surface area of the cropped region of the imaging sensor 11.

The image recorder 18 is an internal memory and/or a removable memory, for example, that records the image signal while referencing specific information to be recorded with the image signal on the basis of a command from the image recording controller 19. The specific information to be recorded along with the image signal includes the date and time the image was captured, focal length information, shutter speed information, aperture value information, and imaging mode information. The format of the information can be the Exif (registered trademark) format, a format similar to the Exif (registered trademark) format, or the like. Moving picture files may be in, for example, the H.264/AVC format or a format similar to the H.264/AVC format.

The display unit 20 is a liquid crystal monitor, for example, and displays as a visible image the image signal recorded to the image recorder 18 or the buffer memory 16 on the basis of a command from an image display controller 21 (an example of a display controller). The display modes of the display unit 20 here are a display mode in which just the image signal is displayed as a visible image, and a display mode in which the image signal and information from the time of capture are displayed as a visible image. The display unit 20 may be a variable-angle monitor with which the angle can be freely changed with respect to the case 3a of the camera body 3.

As shown in FIG. 1, the quick return mirror 23 is constituted by a main mirror 23a capable of reflecting and transmitting incident light, and a sub-mirror 23b that is provided on the rear face side of the main mirror 23a and reflects light transmitted by the main mirror 23a. The quick return mirror 23 can be flipped up outside the optical axis AZ by a quick return mirror controller 36. The incident light is split into two beams by the main mirror 23a, and the reflected beam is guided to the viewfinder optical system 22. Meanwhile, the transmitted beam is reflected by the sub-mirror 23b and utilized as an AF light beam by the focus point detection unit 5. During ordinary imaging, the quick return mirror 23 is flipped up outside the optical axis AZ by the quick return mirror controller 36, the shutter unit 33 is opened, and a subject image is formed on the imaging face of the imaging sensor 11. When imaging is not being performed, as shown in FIG. 1, the quick return mirror 23 is disposed along the optical axis AZ, and the shutter unit 33 is closed.

The viewfinder optical system 22 is constituted by a viewfinder screen 6 on which a subject image is formed, a pentaprism 7 that converts the subject image into an erect image, an eyepiece lens 8 that guides the erect image of the subject to a viewfinder eyepiece window 9, and the viewfinder eyepiece window 9 that is used by the user to view the subject image.

1.2: Interchangeable Lens Unit

As shown in FIG. 1, the interchangeable lens unit 2 mainly comprises an optical system L for forming a subject image on the imaging sensor 11 in the camera system 1, a zoom lens group drive controller 61 that changes the zoom ratio, a focus lens group drive controller 41 that performs focusing, an aperture drive controller 42 that adjusts the aperture, and the lens microcomputer 40 that serves as a lens controller for controlling the operation of the interchangeable lens unit 2.

The zoom lens group drive controller 61 controls the drive of the first zoom lens L1 (hereinafter also referred to as the zoom lens group L1) that adjusts the zoom ratio (focal length) to the telephoto side or the wide angle side. The focus lens group drive controller 41 mainly controls the drive of the second lens group L2 (discussed below; hereinafter also referred to as the focus lens group L2) that adjusts the focus. The aperture drive controller 42 mainly controls the drive of an aperture unit 43 for adjusting how open or closed the aperture is.

The lens microcomputer 40 is the main control apparatus for the interchangeable lens unit 2, and is connected to the various components installed in the interchangeable lens unit 2. More specifically, a CPU, ROM, and RAM are installed in the lens microcomputer 40, and the CPU reads the programs loaded in the ROM, which allows the lens microcomputer 40 to carry out its various functions. Also, the body microcomputer 10 and the lens microcomputer 40 are electrically connected by electrical contacts (not shown) provided to the lens mount 79, allowing information to be exchanged between the two.

The interchangeable lens unit 2 also has a zoom operation lever 64 (an example of a lens operation unit, and an example of a zoom operation unit) and a zoom operation detector 65. The zoom operation lever 64 is used to adjust the zoom ratio (focal length) to the telephoto side or the wide angle side. The zoom operation detector 65 detects that the zoom operation lever 64 has been turned to the telephoto side or the wide angle side, and sends this operation information to the lens microcomputer 40.

If the zoom operation detector 65 detects that the zoom operation lever 64 has been turned to the telephoto side, the lens microcomputer 40 controls the zoom lens group drive controller 61 so that the zoom lens group L1 moves to the telephoto side. On the other hand, if the zoom operation detector 65 detects that the zoom operation lever 64 has been turned to the wide angle side, the lens microcomputer 40 controls the zoom lens group drive controller 61 so that the zoom lens group L1 moves to the wide angle side.

Information related to the focal length or zoom ratio, which changes according to the movement of the zoom lens group L1, is sent from the lens microcomputer 40, through the lens mount 79 and the body mount 4, to the body microcomputer 10. On the basis of this information, as discussed below, information related to the zoom ratio is displayed on the display unit 20, or focal length information is recorded along with an image captured in Exif® (registered trademark) format, or the ratio of electronic zoom is changed.

The interchangeable lens unit 2 also has a focus ring 67 (an example of a lens operation unit, and an example of a focus operation unit) and a rotation detector 68 that detects the amount and direction of rotation of the focus ring 67. The focus ring 67 is used to adjust the focus position (the object distance of the subject when it is in focus; hereinafter also referred to as the subject distance) to the infinity side or the near side. The rotation detector 68 detects that the focus ring 67 has been turned to the infinity side or the near side, and sends this operation information to the lens microcomputer 40.

When the rotation detector 68 detects that the focus ring 67 has been turned to the infinity side, the lens microcomputer 40 controls the focus lens group drive controller 41 so that the focus lens group L2 moves to the infinity side. On the other hand, when the rotation detector 68 detects that the focus ring 67 has been turned to the near side, the lens microcomputer 40 controls the focus lens group drive controller 41 so that the focus lens group L2 moves to the near side.

Further, information related to the object distance (subject distance), which changes according to the movement of the focus lens group L2, is sent from the lens microcomputer 40, through the lens mount 79 and the body mount 4, to the body microcomputer 10.

Various information (an example of lens information) related to the interchangeable lens unit 2 is stored in a memory 44 (an example of a memory unit) of the lens microcomputer 40. This various information will be discussed in more specific terms below. The various information stored in the memory 44 is sent to the camera body 3 side when the interchangeable lens unit 2 is attached to the camera body 3 so that it can be used during imaging.

1.3: Information Related to the Interchangeable Lens Unit

Information related to the interchangeable lens unit 2 will now be described. The memory 44 in the lens microcomputer 40 holds various kinds of information (lens information) related to the interchangeable lens unit 2. More specifically, focal length information indicating the maximum and minimum values for focal length of the interchangeable lens unit 2 (focal length variable range), or the object distance information, etc., is stored in the memory 44.

The memory 44 also holds information related to whether or not the interchangeable lens unit 2 is compatible with the above-mentioned moving picture imaging. This information is recorded to a specific address in the memory 44 (such as an extra address that is not normally used).

One possible criterion for deciding whether or not the interchangeable lens unit 2 is compatible with moving picture imaging can be whether or not the second lens group L2 serving as the focus lens group is capable of wobbling (microscopic reciprocal vibration). It can be concluded that wobbling is possible if the second lens group L2 is supported by guide poles and if the second lens group L2 is driven directly by an ultrasonic actuator or the like. Therefore, the drive method of the second lens group L2 can also be used as information related to whether or not the interchangeable lens unit 2 is compatible with moving picture imaging.

Furthermore, in wobbling in the focus lens group, a constitution in which the amount of change in the magnification of an image on the imaging sensor 11 is at or below a specific value can serve as a criterion for deciding compatibility with moving picture imaging. Accordingly, such information can also be used as information related to whether or not the interchangeable lens unit 2 is compatible with moving picture imaging.

The phrase “is compatible with moving picture imaging” here means that the interchangeable lens unit 2 is compatible with a contrast detection method. Therefore, information about compatibility with contrast detection can also be used as information related to whether or not the interchangeable lens unit 2 is compatible with moving picture imaging.

Furthermore, the memory 44 also stores information related to whether or not the interchangeable lens unit 2 is compatible with electric zoom, and information related to whether or not there is a zoom operation unit (such as a zoom operation lever). Saying that the interchangeable lens unit 2 is compatible with electric zoom means that the zoom lens group L1 is driven electrically in the Z axis direction. In this embodiment, since the zoom lens group L1 is driven by the zoom lens group drive controller 61, it can be said that the interchangeable lens unit 2 is compatible with electric zoom.

The zoom lens group drive controller 61 has an actuator for driving the zoom lens group L1, and a drive circuit for performing speed control or position control by supplying power to the actuator. Examples of actuators for driving the zoom lens group L1 include a stepping motor, a DC motor, an electromagnetic linear motor, and an ultrasonic motor. These actuators all convert electrical power into drive force for the zoom lens group L1.

If this information is stored in the camera system 1, the information is acquired by the body microcomputer 10 on the camera body 3 side when the interchangeable lens unit 2 is attached to the camera body 3. On the basis of the acquired lens information, the body microcomputer 10 decides whether or not moving picture imaging is possible, whether or not there is electric zoom compatibility, and whether or not there is a zoom operation lever. Also, optimal focusing performance can be set for the combination with the camera body 3 by storing focus speed, minimum resolution, and so forth according to the performance of the ultrasonic actuator or other such focus lens group drive actuator. For instance, the frame rate (30 fps, 60 fps, etc.) during moving picture imaging, the recorded pixel count, and so forth can be automatically set for the camera system 1 according to the focusing performance.

This information is sent from the lens microcomputer 40 to the body microcomputer 10 when the interchangeable lens unit 2 is attached to the camera body 3. This allows the body microcomputer 10 to ascertain various information about the interchangeable lens unit 2.

### 2: Operation of Camera System

The imaging operation of the camera system 1 constituted as above will now be described.

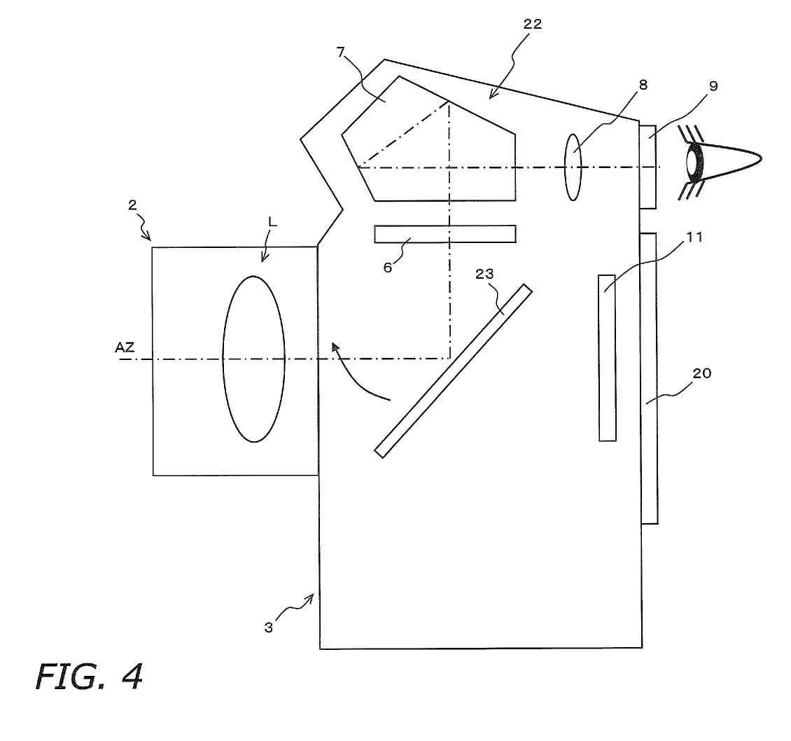

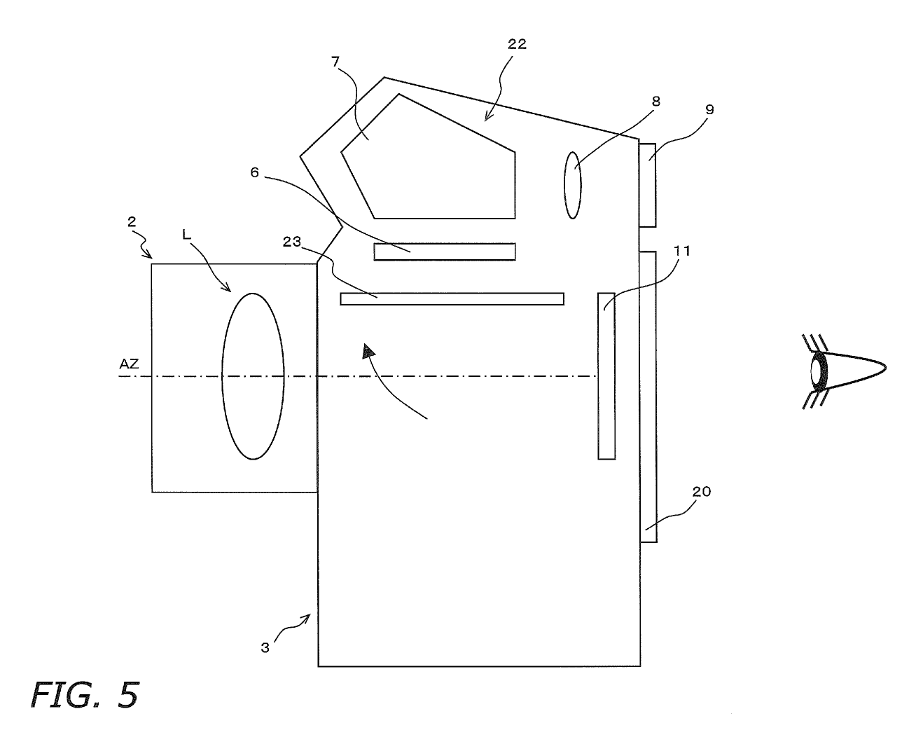

FIGS. 4 and 5 are concept diagrams of during imaging with the camera system 1. FIG. 4 is a diagram illustrating viewfinder imaging mode, and FIG. 5 is a diagram illustrating monitor imaging mode.

2.1: Viewfinder Imaging Mode and Monitor Imaging Mode

This camera system 1 has two imaging modes, namely, a viewfinder imaging mode and a monitor imaging mode. The viewfinder imaging mode is a mode in which the user captures a picture while looking through the viewfinder eyepiece window 9. This is the normal imaging mode in a conventional single lens reflex camera. The monitor imaging mode is a mode in which the user captures a picture while looking at the display unit 20, which is a liquid crystal monitor or the like.

In the viewfinder imaging mode, as shown in FIG. 4, light from the subject (not shown) passes through the interchangeable lens unit 2 and is incident on the main mirror 23a, which is a semi-transmitting mirror. Part of the light incident on the main mirror 23a is reflected and incident on the viewfinder screen 6, and the rest of the light is transmitted and incident on the sub-mirror 23b. Light incident on the viewfinder screen 6 forms a subject image. This subject image is converted into an erect image by the pentaprism 7 and incident on an eyepiece lens 8. This allows the user to view an erect image of the subject through the viewfinder eyepiece window 9. Light that is incident on the sub-mirror 23b is reflected and incident on the focus point detection unit 5.

Thus, in viewfinder imaging mode, as shown in FIG. 4, the quick return mirror 23 is disposed at a specific location within the optical axis AZ, and the subject light is guided to the viewfinder optical system 22, so the user can view the subject image through the viewfinder eyepiece window 9. During actual imaging, the quick return mirror 23 is flipped up outside of the optical axis AZ, and the shutter unit 33 is opened, which forms a subject image on the image face of the imaging sensor 11.

Meanwhile, in monitor imaging mode, as shown in FIG. 5, the quick return mirror 23 is retracted out of the optical axis AZ. Thus, an image of the subject (a so-called through-image) is displayed on the display unit 20 via the imaging sensor 11.

2.2: Operation in Viewfinder Imaging Mode

The imaging operation of the camera system 1 will be described. The drive sequence in viewfinder imaging mode in which the user looks through the viewfinder eyepiece window 9 to capture an image will be described through reference to FIGS. 1 to 4.

When an image is to be captured in viewfinder imaging mode, the user presses the viewfinder switching button 34 provided to the rear face of the case 3a to select the viewfinder imaging mode as the imaging mode.

When the user presses the release button 30 half-way down, power is supplied to the body microcomputer 10 and the various units in the camera system 1. The body microcomputer 10 in the camera system 1 that has been actuated by the supply of power receives various kinds of lens data from the lens microcomputer 40 in the interchangeable lens unit 2, which is similarly actuated by the supply of power, through the lens mount 79 and the body mount 4, and this information is stored in the built-in memory 38. Next, the body microcomputer 10 acquires the amount of defocus (hereinafter referred to as the Df amount) from the focus point detection unit 5, and sends a command to the lens microcomputer 40 to drive the focus lens group L2 by this Df amount. The lens microcomputer 40 controls the focus lens group drive controller 41 and operates the second lens group L2 by the Df amount. While focus point detection and drive of the second lens group L2 are thus repeated, the Df amount decreases, and when it reaches a specific amount or less, the body microcomputer 10 decides that the image is in focus, and drive of the second lens group L2 is stopped.

After this, when the user presses the body release button 30 all the way down, the body microcomputer 10 instructs the lens microcomputer 40 to set the aperture value to the one calculated on the basis of the output from a photometer sensor (not shown). The lens microcomputer 40 then controls the aperture drive controller 42 and stops down the aperture to the indicated aperture value. Simultaneously with this aperture value command, the body microcomputer 10 retracts the quick return mirror 23 from within the optical axis AZ with the quick return mirror controller 36. Once the quick return mirror 23 has been completely retracted, the imaging sensor drive controller 12 directs the imaging sensor 11 to be driven, and directs the shutter unit 33 to be operated. The imaging sensor drive controller 12 also exposes the imaging sensor 11 for the time of the shutter speed calculated on the basis of the output from a photometer sensor (not shown).

Upon completion of the exposure, the image data read by the imaging sensor drive controller 12 from the imaging sensor 11 is subjected to specific image processing, after which it is displayed as a captured image on the display unit 20. The image data that has been read from the imaging sensor 11 and subjected to the specific image processing is written via the image recorder 18 as image data to a storage medium. Also, upon the completion of exposure, the quick return mirror 23 and the shutter unit 33 are reset to their initial positions. The body microcomputer 10 directs the lens microcomputer 40 to reset the aperture to its open position, and the lens microcomputer 40 issues a reset command to the various units. Upon completion of the resetting, the lens microcomputer 40 notifies the body microcomputer 10 that resetting is complete. The body microcomputer 10 awaits the completion of the series of processing after exposure and the resetting completion information from the lens microcomputer 40, after which it is confirmed that the release button 30 has not been pressed, and the imaging sequence is ended.

2.3: Operation in Monitor Imaging Mode

The drive sequence in monitor imaging mode, in which the user uses the display unit 20 to capture an image, will now be described through reference to FIGS. 1 to 3B and FIG. 5.

When the display unit 20 is used for imaging, the user presses the viewfinder switching button 34 to select the monitor imaging mode. When the monitor imaging mode is set, the body microcomputer 10 retracts the quick return mirror 23 from within the optical axis AZ. Consequently, light from the subject reaches the imaging sensor 11. The imaging sensor 11 converts light from the subject that has been imaged on the imaging sensor 11 into image data, and the image data thus acquired can be outputted. The image data read from the imaging sensor 11 by the imaging sensor drive controller 12 undergoes specific image processing, after which it is displayed as a captured image on the display unit 20. Thus displaying the captured image on the display unit 20 allows the user to follow the subject without having to look through the viewfinder eyepiece window 9.

Regarding this monitor imaging mode, when the moving picture imagine mode has been selected with the mode switching dial 26, there is an automatic switch to monitor imaging mode. Furthermore, there is an automatic switch to monitor imaging mode when the moving picture imaging button 35 has been pressed. A camera having a display unit 20 (such as an LCD monitor) that can be opened and closed may be designed so that the mode is automatically switched to monitor imaging mode when the display unit 20 is opened by the user.

In this monitor imaging mode, contrast detection-type autofocusing, which is based on image data produced by the imaging sensor 11, is used as the focusing method instead of a phase difference detection method in which the focus point detection unit 5 is used. When a contrast detection method is used as the method for autofocusing in the monitor imaging mode with the display unit 20, precise focusing can be achieved with the camera system. In this monitor imaging mode, autofocusing by contrast method in which image data is used is easier than a conventional phase difference detection method since image data is produced by the imaging sensor 11 in a steady state.

The autofocusing operation by contrast method will now be described.

When performing autofocusing by contrast method, the body microcomputer 10 requests contrast AF data from the lens microcomputer 40. This contrast AF data is necessary in autofocusing by contrast method, and includes, for example, the focus drive speed, the amount of focus shift, the zoom ratio, and information about whether or not contrast AF is possible.

The body microcomputer 10 periodically produces a vertical synchronization signal. The body microcomputer 10 produces an exposure synchronization signal in parallel with this on the basis of the vertical synchronization signal. This allows an exposure synchronization signal to be produced because the body microcomputer 10 ascertains ahead of time the exposure start and end timing, using the vertical synchronization signal as a reference. The body microcomputer 10 outputs the vertical synchronization signal to a timing generator (not shown), and outputs the exposure synchronization signal to the lens microcomputer 40. The lens microcomputer 40 synchronizes with the exposure synchronization signal and acquires position information about the second lens group L2.

The imaging sensor drive controller 12 periodically produces an electronic shutter drive signal and the read signal of the imaging sensor 11 on the basis of the vertical synchronization signal. The imaging sensor drive controller 12 drives the imaging sensor 11 on the basis of the electronic shutter drive signal and the read signal. Specifically, the imaging sensor 11 reads to a vertical transfer part (not shown) the image data produced by numerous opto-electrical conversion elements (not shown) present in the imaging sensor 11, according to the read signal.

In still picture imaging mode, the user presses the release button 30 half-way down, and the body microcomputer 10 of the camera system 1 receives various kinds of lens data from the lens microcomputer 40 in the interchangeable lens unit 2 via the lens mount 79 and the body mount 4, and this data is stored in the built-in memory 38. Also, the body microcomputer 10 sends an autofocus start command to the lens microcomputer 40. When the release button 30 is pressed down half-way, the autofocus start command is a command to start the autofocusing operation by contrast method. On the basis of this command, the lens microcomputer 40 controls the drive of the second lens group L2 along the optical axis AZ. The body microcomputer 10 calculates an evaluation value for use in autofocusing (hereinafter referred to as the AF evaluation value) on the basis of the received image data. More specifically, there is a known method in which a brightness signal is found from the image data produced by the imaging sensor 11, the high-frequency part of the brightness signal on the screen is added up, and the AF evaluation value is found. The calculated AF evaluation value is stored in a DRAM (not shown) in a state of being associated with the exposure synchronization signal. The lens position information acquired from the lens microcomputer 40 is also associated with the exposure synchronization signal. Accordingly, the body microcomputer 10 can store the AF evaluation value in association with lens position information.

Next, the body microcomputer 10 finds the contrast peak on the basis of the AF evaluation value stored in the DRAM, and monitors whether or not the focus point has been selected. More specifically, the position of the second lens group L2 at which the AF evaluation value is at its maximum value is selected as the focus point. The mountain climbing method is commonly known as this lens drive method.

In this state, the camera system 1 displays the image data produced by the imaging sensor 11 as a through-image (what is known as a live view image) on the display unit 20. Since this through-image is displayed as a moving picture on the display unit 20, the user can determine the composition for capturing a still picture while looking at the display unit 20.

After this, when the user presses the release button 30 all the way down, the body microcomputer 10 directs that the aperture value be set to the one calculated on the basis of the output from a photometer sensor (not shown). The lens microcomputer 40 then controls the aperture drive controller 42 and stops down the aperture until the indicated aperture value is reached. The imaging sensor drive controller 12 directs that the imaging sensor 11 be driven, and directs that the shutter unit 33 be operated. The imaging sensor drive controller 12 also exposes the imaging sensor 11 for the length of time of the specific shutter speed calculated from the output of the imaging sensor 11.

Upon completion of the exposure, the image data read from the imaging sensor 11 by the imaging sensor drive controller 12 is subjected to specific image processing, after which it is displayed as a captured imaged on the display unit 20. Also, the image data read from the imaging sensor 11 and subjected to the specific image processing is written via the image recorder 18 as image data to a storage medium. Also, upon completion of exposure, the quick return mirror 23 is positioned in a state of being retracted from within the optical axis AZ, so the user can then use the monitor imaging mode to view the subject as a captured image on the display unit 20.

Similarly, in moving picture mode, the user presses the release button 30 all the way down to perform moving picture recording. Regardless of the mode, moving picture recording can be performed by pressing the moving picture imaging button 35. Furthermore, if the interchangeable lens unit 2 is compatible with moving picture imaging, the mode may be automatically switched to moving picture mode when the interchangeable lens unit 2 is attached to the camera body 3.

When the monitor imaging mode is to be exited, the user presses the viewfinder switching button 34, and the system switches to the viewfinder imaging mode in which the subject is viewed through the viewfinder eyepiece window 9. When the mode is changed to viewfinder imaging mode, the quick return mirror 23 is returned to its specific position in the optical axis AZ. The quick return mirror 23 is also returned to its specific position in the optical axis AZ when the power to the camera system 1 is switched off.

2.4: Zoom Operation Selection Processing

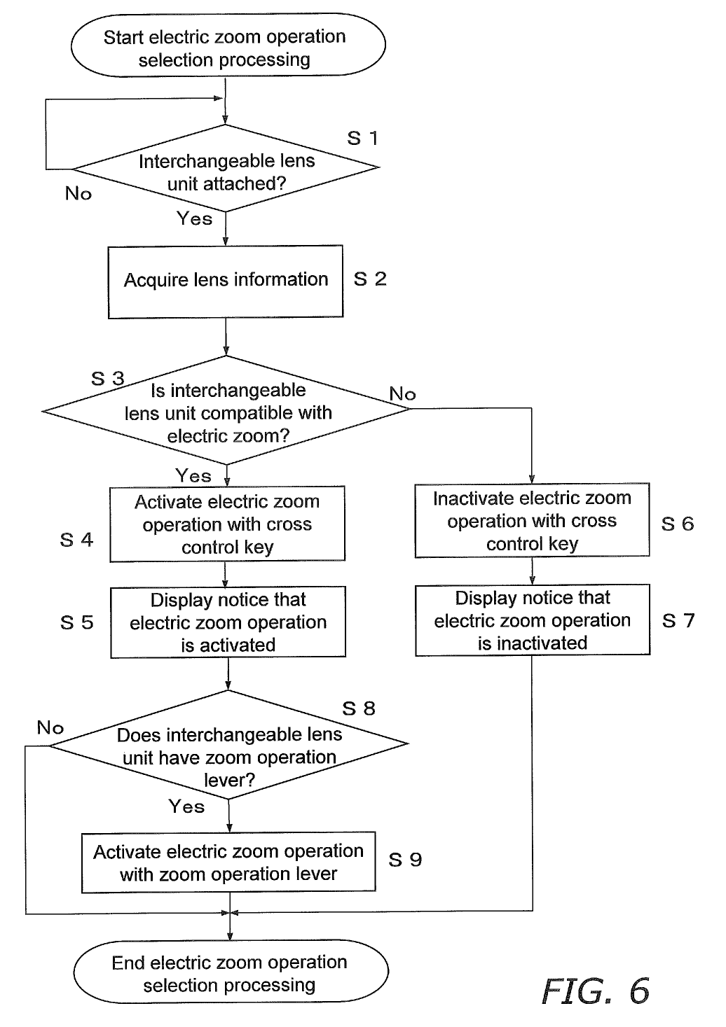

Next, zoom operation selection processing when an interchangeable lens unit is attached to a camera body will be described through reference to FIG. 6. FIG. 6 is a flowchart of zoom selection processing.

As shown in FIG. 6, first the body microcomputer 10 of the camera body 3 decides whether or not an interchangeable lens unit 2 has been attached to the camera body 3 (step 51). If it is decided that an interchangeable lens unit 2 has been attached to the camera body 3, the body microcomputer 10 acquires lens information stored in the memory 44 of the interchangeable lens unit 2 (step S2). The body microcomputer 10 decides whether or not the interchangeable lens unit 2 is compatible with electric zoom on the basis of the acquired lens information (step S3).

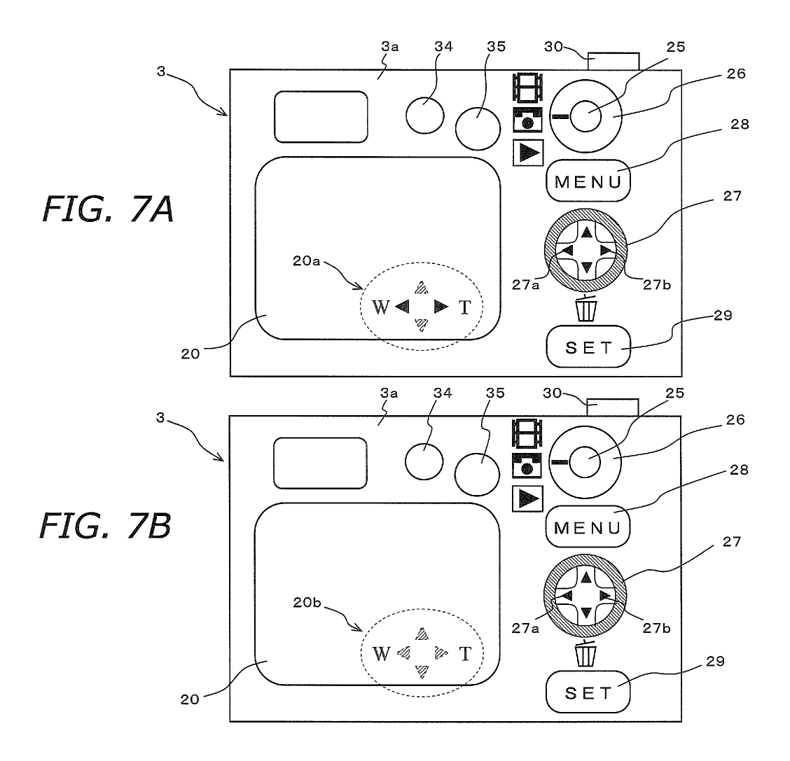

If the interchangeable lens unit 2 is compatible with electric zoom, the body microcomputer 10 assigns an electric zoom operation function to the cross control key 27, and electric zoom operation with the cross control key 27 is activated (step S4). Then, a display is made on the display unit 20 to the effect that electric zoom operation with the cross control key 27 is activated (step S5). Here, as shown in FIG. 7A, the electric zoom operation function is assigned to the cross control key 27 so that the zoom ratio is changed to the direction of the wide angle side (W) when the left operation unit 27a of the cross control key 27 is pressed. An operation direction to the wide angle side (W) is displayed on the display unit 20, as with the zoom display part 20a of the display unit 20. Meanwhile, the electric zoom operation function is assigned to the cross control key 27 so that the zoom ratio is changed to the direction of the telephoto side (T) when the right operation unit 27b of the cross control key 27 is pressed. An operation direction to the telephoto side (T) is displayed on the display unit 20, as with the zoom display part 20a of the display unit 20. Displaying the zoom display part 20a makes it easy for the user to tell whether the left and right operation units 27a and 27b of the cross control key 27 correspond to the wide angle side or telephoto side.

If the interchangeable lens unit 2 is not compatible with an electric zoom function, the body microcomputer 10 does not assign an electric zoom operation function to the cross control key 27 (or the assignment of the electric zoom operation function by the body microcomputer 10 to the cross control key 27 is cancelled), and electric zoom operation with the cross control key 27 is inactivated (step S6). At this point the body microcomputer 10 may assign another operation function to the cross control key 27.

Next, a display is made on the display unit 20 to the effect that electric zoom operation with the cross control key 27 is inactivated (step S7). Here, as shown in FIG. 7B, because the electric zoom operation function of the cross control key 27 is inactivated, the arrow indicating the operation directions to the wide angle side (W) and telephoto side (T) is grayed out (indicating that it cannot be used), as with the zoom display part 20b of the display unit 20. This makes it easy for the user to tell that electric zoom operation with the cross control key 27 is impossible. After step S7, the zoom operation selection processing is ended.

In the processing of step S7, a display is made on the display unit 20 to the effect that the electric zoom operation function is inactivated, but a display to the effect that the electric zoom operation function is inactivated need not be made on the display unit 20.

If the interchangeable lens unit 2 is compatible with electric zoom, after step S5 the body microcomputer 10 decides, on the basis of lens information, whether or not the zoom operation lever 64 (an example of a lens operation unit) is installed in the interchangeable lens unit 2 (step S8). If the zoom operation lever 64 is not installed in the interchangeable lens unit 2, the zoom operation selection processing is ended.

If the zoom operation lever 64 is installed in the interchangeable lens unit 2, the body microcomputer 10 assigns an electric zoom operation function to the zoom operation lever 64, and electric zoom operation with the cross control key 27 becomes activated (step S9).

More specifically, as discussed above, the zoom operation detector 65 detects that the zoom operation lever 64 has been turned to the telephoto side or wide angle side, and this operation information is sent from the zoom operation detector 65 to the lens microcomputer 40. If the zoom operation detector 65 detects that the zoom operation lever 64 has been turned to the telephoto side, the lens microcomputer 40 controls the zoom lens group drive controller 61 so that the zoom lens group L1 moves to the telephoto side. As a result, the zoom lens group L1 is driven by the zoom lens group drive controller 61 so that the zoom ratio changes to the telephoto side.

On the other hand, if the zoom operation detector 65 detects that the zoom operation lever 64 has been turned to the wide angle side, the lens microcomputer 40 controls the zoom lens group drive controller 61 so that the zoom lens group L1 moves to the wide angle side. As a result, the zoom lens group L1 is driven by the zoom lens group drive controller 61 so that the zoom ratio changes to the wide angle side.

Information related to the zoom ratio or focal length, which varies according to the movement of the zoom lens group L1, is sent from the lens microcomputer 40, through the lens mount 79 and the body mount 4, to the body microcomputer 10. On the basis of this information, as will be discussed below, information related to the zoom ratio is displayed on the display unit 20, or focal length information is recorded along with an image captured in Exif® (registered trademark) format, or the ratio of electronic zoom is changed.

2.5: Electronic Zoom Operation Selection Processing

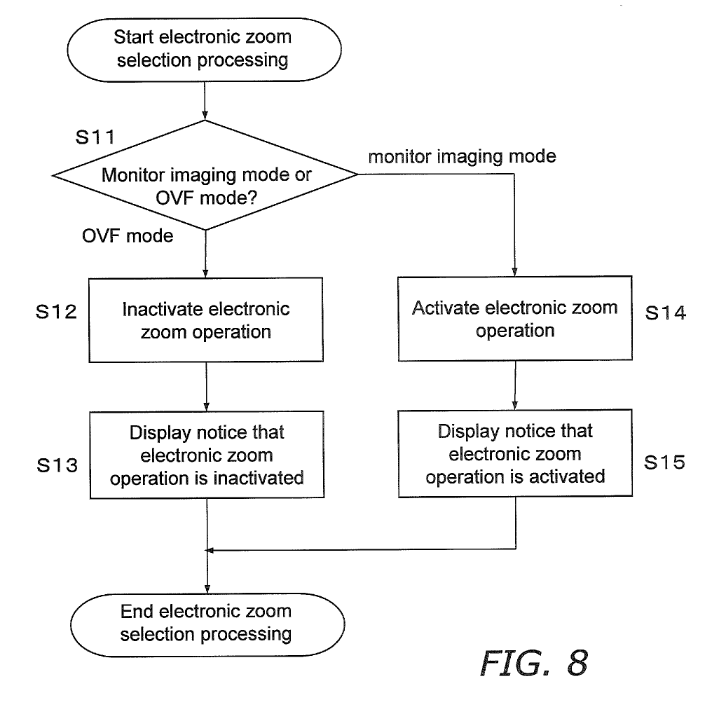

Next, electronic zoom operation selection processing will be described through reference to FIG. 8. FIG. 8 is a flowchart of electronic zoom selection processing. An example will be described in which an interchangeable lens unit 2 that is compatible with electric zoom and that has a zoom operation lever 64 is mounted to the camera body 3.

As shown in FIG. 8, first the user presses the viewfinder switching button 34 provided on the rear face of the case 3a to select the viewfinder imaging mode (hereinafter referred to as OVF mode (optical viewfinder mode)) or the monitor imaging mode as the imaging mode. If OVF mode is selected, the processing proceeds to step S12. On the other hand, if monitor imaging mode is selected, the processing proceeds to step S14.

If the selected imaging mode is the OVF mode, the user views the subject image through the viewfinder eyepiece window 9, and the light that has passed through the optical system L is not incident on the imaging sensor 11. Accordingly, an electronic zoom function in which part of the image acquired by the imaging sensor 11 is cropped and subjected to digital processing can't be utilized. Therefore, when the OVF mode is selected in step S11, the body microcomputer 10 dose not assign an electronic zoom operation function to the cross control key 27 (or the assignment of the electronic zoom operation function by the body microcomputer 10 to the cross control key 27 is cancelled), and electronic zoom operation is inactivated (step S12).

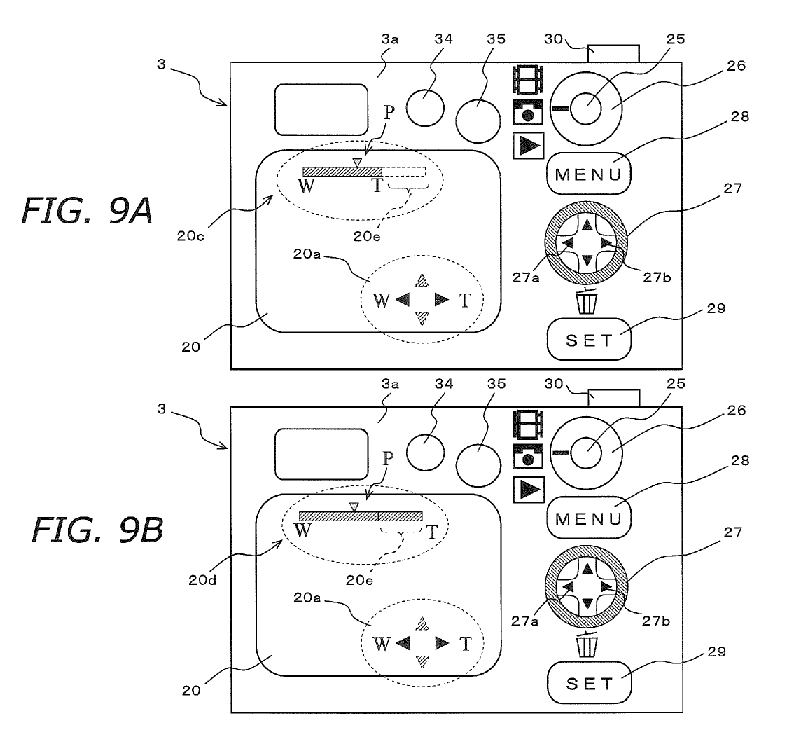

Next, a notification that electronic zoom is inactivated is displayed on the display unit 20 (step S13). Here, the wide angle side (W) and telephoto side (T) are displayed as a gauge, and the current zoom ratio is displayed on this gauge as the current value P, as with the zoom state indicator 20c in FIG. 9A. The gauge region to the right of the telephoto side (T) (the region 20e indicated by a broken line) shows the region of electronic zoom. The fact that the region 20e is indicated by a broken line means that electronic zoom is inactivated. In this case, the zoom operation cannot switch from electric zoom to electronic zoom so as to further raise the zoom ratio from the telephoto side T.

On the other hand, when the selected imaging mode is the monitor imaging mode, a real-time image is acquired by the imaging sensor 11 so that the user can view the subject image on the display unit 20. That is, an electronic zoom function can be utilized in monitor imaging mode. Therefore, when the monitor imaging mode is selected in step S11, the body microcomputer 10 assigns an electronic zoom operation function to the cross control key 27, and electronic zoom operation is activated (step S14). A notification to the effect that electronic zoom operation is activated is then displayed on the display unit 20 (step S15). Here, the wide angle side (W) and telephoto side (T) are displayed as a gauge, and the current zoom ratio is displayed on this gauge as the current value P, as with the zoom state indicator 20d in FIG. 9B. The gauge region 20e to the right of the telephoto side (T) shows the region of electronic zoom. The fact that the region 20e is indicated by a solid line means that electronic zoom is activated. In this case, the zoom operation can switch from electric zoom to electronic zoom so as to further raise the zoom ratio from the telephoto side T.

2.6: Zoom Operation Unit Priority Processing

If the interchangeable lens unit 2 is compatible with electric zoom and has the zoom operation lever 64, then electric zoom operation is possible with both the cross control key 27 and the zoom operation lever 64, as in the flowchart shown in FIG. 6. Therefore, when the user changes the zoom ratio, two situations are possible: one in which the zoom operation lever 64 mounted on the interchangeable lens unit 2 is operated, and one in which the cross control key 27 mounted on the camera body 3 is operated. For example, when the zoom operation lever 64 and the cross control key 27 are both operated at the same time, there is the danger that the zoom operations will conflict, causing damage to the system.

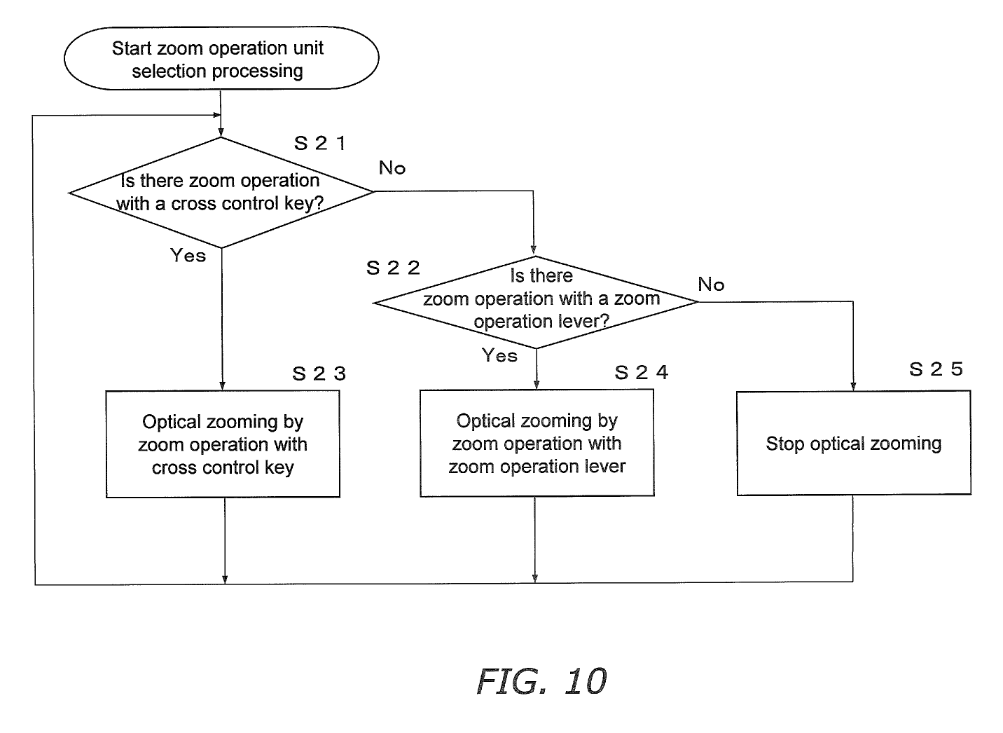

In view of this, with this camera system 1, in order to prevent system damage in the event that the zoom operation lever 64 and the cross control key 27 are operated at the same time, when operation is activated for both the zoom operation lever 64 and the cross control key 27, the body microcomputer 10 performs zoom operation unit priority processing. This zoom operation unit priority processing will be described through reference to FIG. 10. FIG. 10 is a flowchart of when the cross control key 27 mounted on the camera body 3 is given priority.

As shown in FIG. 10, first the body microcomputer 10 of the camera body 3 determines whether or not zoom operation is being performed with the cross control key 27 (step S21). If the body microcomputer 10 determines that zoom operation has been performed with the cross control key 27, the zoom lens group L1 is driven by the zoom lens group drive controller 61 according to the zoom operation of the cross control key 27, and optical zooming is performed (step S23). After this, the processing returns to step S21, but if the user is still performing zoom operation with the cross control key 27 (such as when the cross control key 27 is being held down), the processing of steps S21 and S23 is repeated at a specific period (such as at 1 ms intervals). Here, since only zoom operation with the cross control key 27 is being monitored, even if the zoom operation lever 64 is operated, that operation information will be ignored. In other words, while steps S21 and S23 are being repeated, zoom operation with the zoom operation lever 64 is temporarily inactivated.

If zoom operation with the cross control key 27 is being continued by the user, it is also conceivable that the drive of the zoom lens group L1 will be continued up to a specific zoom ratio once the cross control key 27 is pressed. In this case, the processing moves on to step S21 after the drive of the zoom lens group L1 is complete.

In step S21, if the body microcomputer 10 determines that zoom operation is not being performed with the cross control key 27, then the body microcomputer 10 determines whether or not zoom operation is being performed with the zoom operation lever 64 mounted to the interchangeable lens unit 2 (step S22). More specifically, the lens microcomputer 40 sends operation information about the zoom operation lever 64 to the body microcomputer 10 at a specific period. The body microcomputer 10 determines whether or not zoom operation is being performed with the zoom operation lever 64 on the basis of this operation information.

If the body microcomputer 10 has determined that zoom operation is being performed with the zoom operation lever 64, the zoom lens group L1 is driven by the zoom lens group drive controller 61 according to the zoom operation of the zoom operation lever 64, and optical zooming is performed (step S24).

After zoom operation with the zoom operation lever 64 is complete, the processing returns to step S21, but if the user is continuing zoom operation not with the cross control key 27, but with the zoom operation lever 64 (such as when the zoom operation lever 64 is being held down), then the processing of steps S21, S22, and S24 is repeated at a specific period (such as at 1 ms intervals). If the cross control key 27 is pressed while steps S21, S22, and S24 are being repeated, steps S21 and S23 are repeated. In other words, even when the zoom operation lever 64 is operated, if the cross control key 27 is operated, the operation information inputted by the zoom operation lever 64 is ignored, and zoom operation with the zoom operation lever 64 is inactivated. That is, zoom operation with the cross control key 27 is given priority.

If the user is continuing zoom operation with the zoom operation lever 64, it is also conceivable that the drive of the zoom lens group L1 will be continued up to a specific zoom ratio once the zoom operation lever 64 is pressed. In this case, the processing moves on to step S21 after the drive of the zoom lens group L1 is complete in step S24.

In step S22, if the body microcomputer 10 determines that zoom operation is not being performed with the zoom operation lever 64, that is, that neither the cross control key 27 nor the zoom operation lever 64 is being operated, optical zooming is stopped (step S25). Here again, the processing of steps S21, S22, and S24 is repeated at a specific period (such as at 1 ms intervals).

As discussed above, if the drive of the zoom lens group L1 is continued to a specific zoom ratio once the user has operated the cross control key 27 or the zoom operation lever 64 to which a zoom operation function has been assigned, exceptional processing may be executed in which the processing of step S23 or step S24 is continued until the optical zooming is complete.

As described through reference to FIG. 10, even if the user should operate the zoom operation lever 64 and the cross control key 27 at the same time while changing the zoom ratio, since there is no conflict between zoom operation functions on the interchangeable lens unit 2 side and the camera body 3 side, damage to the system is prevented and the zoom operation function can work stably.

In particular, with the flowchart shown in FIG. 10, since whether or not zoom operation is being performed with the cross control key 27 is determined prior to whether or not there is zoom operation with the zoom operation lever 64, operation of the cross control key 27 is given priority not only while zoom operation is being performed with the cross control key 27, but also while zoom operation is being performed with the zoom operation lever 64.

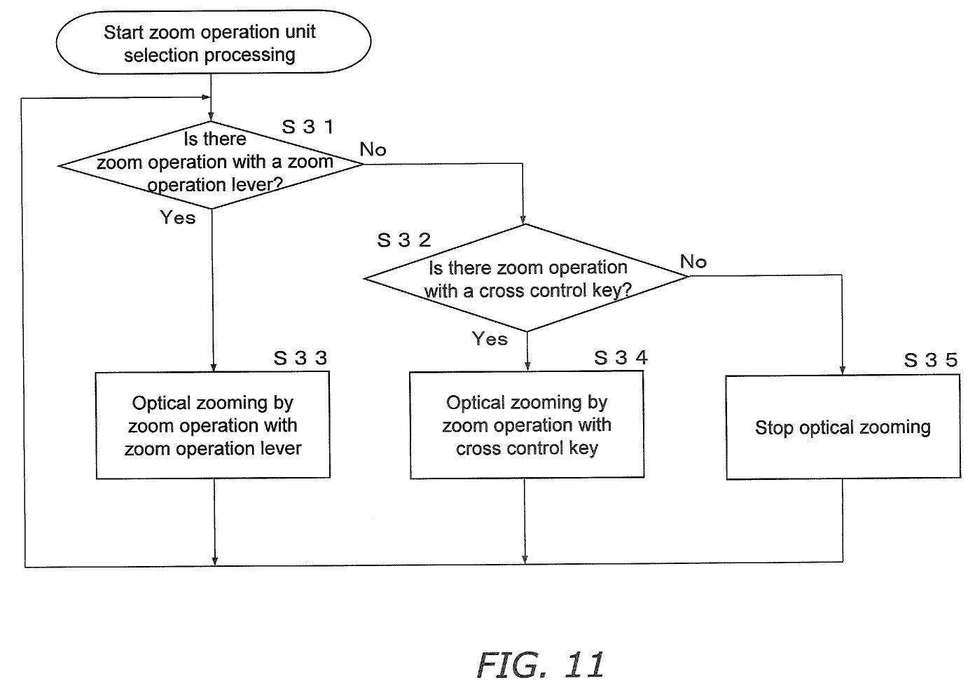

Next, a situation in which the zoom operation lever 64 mounted to the interchangeable lens unit 2 is given priority will be described through reference to FIG. 11.

As shown in FIG. 11, first the body microcomputer 10 of the camera body 3 determines whether or not zoom operation is being performed with the zoom operation lever 64 (step S31). More specifically, the lens microcomputer 40 sends operation information about the zoom operation lever 64 to the body microcomputer 10 at a specific period. The body microcomputer 10 determines whether or not zoom operation is being performed with the zoom operation lever 64 on the basis of this operation information.

If the body microcomputer 10 has determined that zoom operation is being performed with the zoom operation lever 64, the zoom lens group L1 is driven by the zoom lens group drive controller 61 according to the zoom operation of the zoom operation lever 64, and optical zooming is performed (step S33). After this, the processing returns to step S31, but if the user is continuing zoom operation with the zoom operation lever 64 (such as when the zoom operation lever 64 is being held down), then the processing of steps S31 and S33 is repeated at a specific period (such as at 1 ms intervals). If the cross control key 27 is pressed at this time, the operation information thereof is ignored. In other words, since only zoom operation with the zoom operation lever 64 is being monitored while steps S31 and S33 are being repeated, zoom operation with the cross control key 27 is temporarily inactivated.

If the user is continuing zoom operation with the zoom operation lever 64, it is also conceivable that the drive of the zoom lens group L1 will be continued up to a specific zoom ratio once the zoom operation lever 64 is pressed. In this case, the processing moves on to step S31 after the drive of the zoom lens group L1 is complete.

In step S31, if the body microcomputer 10 determines that zoom operation is not being performed with the zoom operation lever 64, then the body microcomputer 10 determines whether or not zoom operation is being performed with the cross control key 27 mounted to the camera body 3 (step S32). If the body microcomputer 10 determines that zoom operation is being performed with the cross control key 27, the zoom lens group L1 is driven by the zoom lens group drive controller 61 according to the zoom operation with the cross control key 27, and optical zooming is performed (step S34).

After zoom operation with the cross control key 27 is complete, the processing returns to step S31, but if the user is continuing zoom operation not with the zoom operation lever 64, but with the cross control key 27 (such as when the cross control key 27 is being held down), then the processing of steps S31, S32, and S34 is repeated at a specific period (such as at 1 ms intervals).

In step S32, if the body microcomputer 10 determines that zoom operation is not being performed with the cross control key 27, that is, that neither the cross control key 27 nor the zoom operation lever 64 is being operated, optical zooming is stopped (step S35). Here again, the processing of steps S31, S32, and S35 is repeated at a specific period (such as at 1 ms intervals).

As discussed above, if the drive of the zoom lens group L1 is continued to a specific zoom ratio once the user has operated the cross control key 27 or the zoom operation lever 64 to which a zoom operation function has been assigned, exceptional processing may be executed in which the processing of step S33 or step S34 is continued until the optical zooming is complete.

As described through reference to FIG. 11, even if the user should operate the zoom operation lever 64 and the cross control key 27 at the same time while changing the zoom ratio, since there is no conflict between zoom operation functions on the lens side and the camera body side, damage to the system is prevented and the zoom operation function can work stably.

In particular, with the flowchart shown in FIG. 11, since whether or not zoom operation is being performed with the zoom operation lever 64 is determined prior to whether or not there is zoom operation with the cross control key 27, operation of the zoom operation lever 64 is given priority not only while zoom operation is being performed with the zoom operation lever 64, but also while zoom operation is being performed with the cross control key 27.

As discussed above, zoom operation conflict can be prevented by giving priority to zoom operation with either the zoom operation lever 64 or the cross control key 27. Consequently, damage to the system can be prevented, and zoom operation is made more convenient.

2.9: Zooming and Focusing

The operation of the interchangeable lens unit 2 when the user performs zooming and manual focusing will now be described.

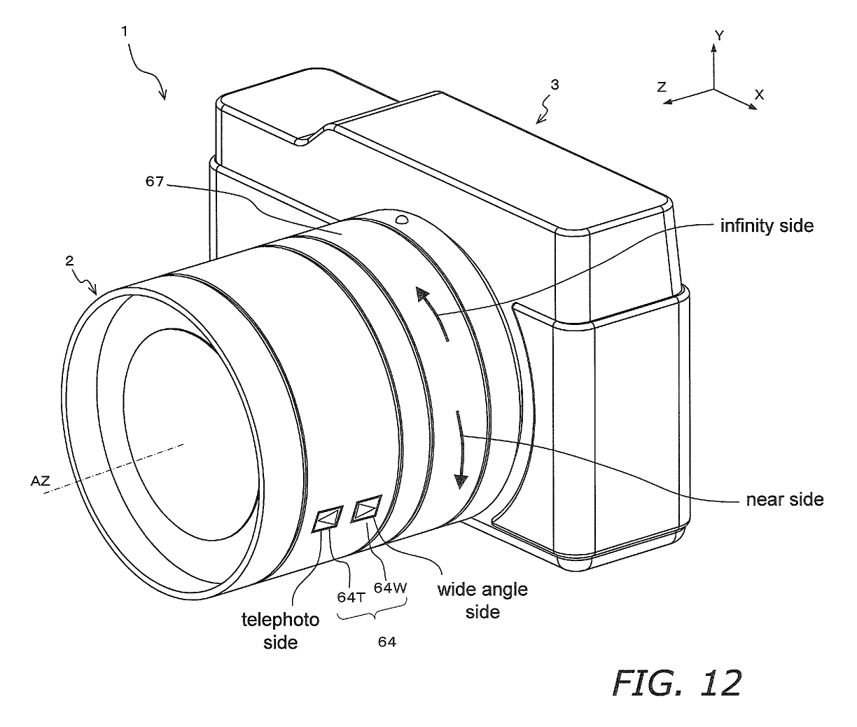

As shown in FIG. 12, when the user operates the zoom operation lever 64, the zoom operation detector 65 detects that the zoom operation lever 64 has been turned either to the telephoto side (64T) or the wide angle side (64W). The lens microcomputer 40 sends control information to the zoom lens group drive controller 61 on the basis of this detection result. If the zoom operation is to the telephoto side (64T), then the zoom lens group L1 is driven to the telephoto side by the zoom lens group drive controller 61, but if the zoom operation is to the wide angle side (64W), the zoom lens group L1 is driven to the wide angle side by the zoom lens group drive controller 61.

When the user turns the focus ring 67, the rotation detector 68 detects the rotational direction and rotational angle of the focus ring 67, and outputs a signal corresponding to the rotational direction and rotational angle. The lens microcomputer 40 sends a drive signal for driving the focus lens group L2 to the focus lens group drive controller 41 on the basis of the rotation information send from the rotation detector 68. If the rotation detector 68 has detected that the focus ring 67 has been turned to the infinity side, the focus lens group L2 is driven to the infinity side by the focus lens group drive controller 41 on the basis of the drive signal sent from the lens microcomputer 40. If the rotation detector 68 has detected that the focus ring 67 has been turned to the near side, the focus lens group L2 is driven to the near side by the focus lens group drive controller 41.

2.8: Focusing Operation

The focusing operation of the camera system 1 will now be described. The camera system 1 has two focus modes: an autofocus imaging mode and a manual focus imaging mode. Also, there are two kinds of manual focus imaging mode: mechanical manual mode and electric manual mode. The mechanical manual mode is a mode in which the focus lens group L2 is mechanically driven according to rotation of the focus ring 67. Electric manual mode is a mode in which the rotation of the focus ring 67 is first converted into an electrical signal, a motor or other such actuator is driven by this electrical signal, and the focus lens group L2 is moved. In the description that follows, “manual focus imaging mode” refers to “electrical manual mode.”

The user selects autofocus imaging mode or manual focus imaging mode by using a focus imaging mode setting button (not shown) provided to the camera body 3 or the interchangeable lens unit 2.

In autofocus imaging mode, the lens microcomputer 40 sends a control signal to the focus lens group drive controller 41 according to operation of the moving picture imaging button 35 or to the release button 30 being pressed half-way down, and nudges the focus lens group L2. The body microcomputer 10 sends a command to the digital signal processor 15. The digital signal processor 15 sends an image signal at a specific timing to the body microcomputer 10 on the basis of the received command. The body microcomputer 10 computes the amount of movement along the optical axis AZ of the second lens group L2 that will result in the optical system L being in a focused state on the basis of the received image signal and focal length information received from the zoom operation detector 65 or a zoom ring rotational angle detector 70. The body microcomputer 10 produces a control signal on the basis of the computation result, and sends the control signal thus produced to the focus lens group drive controller 41. The focus lens group drive controller 41 moves the focus lens group L2 in the Z axis direction to the focus position on the basis of the control signal received from the body microcomputer 10.

Focusing in autofocus imaging mode is performed s discussed above. The above-mentioned operation is executed instantly after the user presses the release button 30 half-way down, or after the moving picture imaging button 35 is pressed. When the user presses the release button 30 half-way down, or presses the moving picture imaging button 35, the body microcomputer 10 executes imaging processing. Upon completion of the imaging, the body microcomputer 10 sends a control signal to the image recording controller 19. The image recording controller 19 issues a command to the image recorder 18 on the basis of this control signal. The image recorder 18 records the image signal to an internal memory and/or removable memory on the basis of the command from the image recording controller 19. The image recorder 18 records information to the effect that the imaging mode is the autofocus imaging mode, along with the image signal, to an internal memory and/or removable memory on the basis of the command from the image recording controller 19.

On the other hand, in manual focus imaging mode, the lens microcomputer 40 asks the focus lens group drive controller 41 for information about the rotational operation of the focus ring unit 66. The lens microcomputer 40 produces a control signal for moving the second lens group L2 on the basis of information about the rotational operation of the focus ring 67, and sends the control signal thus produced to the focus lens group drive controller 41.

The focus lens group drive controller 41 moves the focus lens group L2 in the Z axis direction on the basis of a control signal from the lens microcomputer 40 according to the rotational amount and rotational direction of the focus ring 67.

Focusing in manual focus imaging mode is carried out as above. In manual focus imaging mode, when the user presses the release button 30 all the way down, or presses the moving picture imaging button 35, imaging is performed in a state in which the position of the focus lens group L2 at the point of operation is maintained.

Upon completion of the imaging, the body microcomputer 10 sends a control signal to the image recording controller 19. The image recording controller 19 issues a command to the image recorder 18 on the basis of this control signal. The image recorder 18 records the image signal to an internal memory and/or removable memory on the basis of the command from the image recording controller 19. The image recorder 18 records information to the effect that the imaging mode is the manual focus imaging mode, along with the image signal, to an internal memory and/or removable memory on the basis of the command from the image recording controller 19.

### 3: Features of Camera System

The camera system 1 described above has the following features.

(1)

In the field of interchangeable lens digital cameras, there are interchangeable lens units that are compatible with electric zoom, and interchangeable lens units that are not compatible with electric zoom. Also, an interchangeable lens unit that is compatible with electric zoom may be equipped with a zoom ring, zoom lever, or other such zoom operation unit.

However, with a conventional camera body, even if an interchangeable lens unit that is compatible with electric zoom is mounted, since such an interchangeable lens unit was never intended to be used, there is the risk of system mismatching.

With this camera system 1, lens information is acquired from the interchangeable lens unit 2 by the body microcomputer 10. The body microcomputer 10 then determines whether or not the interchangeable lens unit 2 is compatible with electric zoom on the basis of the acquired lens information. Based on this determination result, zoom operation with the cross control key 27 is activated by the body microcomputer 10.

For example, if the interchangeable lens unit 2 is compatible with electric zoom, zoom operation with the cross control key 27 is activated by the body microcomputer 10. Accordingly, the camera body 3 will be compatible with an interchangeable lens unit 2 that is compatible with electric zoom, so interchangeability with more interchangeable lens units 2 can be ensured.

(2)

As shown in FIG. 6, if the interchangeable lens unit 2 is not compatible with electric zoom, then zoom operation with the cross control key 27 is inactivated by the body microcomputer 10, which prevents the user from accidentally zooming.

(3)

As shown in FIG. 6, since zoom operation with the zoom operation lever 64 is activated by the body microcomputer 10, when the zoom operation lever 64 is mounted to the interchangeable lens unit 2, for example, zoom operation with the zoom operation lever 64 will be possible. Consequently, the zoom operation lever 64 of the interchangeable lens unit 2 can be utilized effectively. Also, interchangeability with more interchangeable lens units 2 can be ensured.

In particular, since zoom operation is possible with either the cross control key 27 or the zoom operation lever 64, the cross control key 27 and the zoom operation lever 64 can be used as dictated by the situation, which makes the camera system 1 more convenient to use.

The constitution may also be such that the user selects either the cross control key 27 or the zoom operation lever 64. For instance, a switch may be provided to the interchangeable lens unit 2 and/or the camera body 3. In this case, zoom operation can be selected as desired by the user, which makes the product more convenient to use. Also, accidental operation can be prevented by inactivating operation with the zoom operation unit that is not being used.

(4)

With the flowchart shown in FIG. 10, zoom operation with the cross control key 27 is given priority not only while zoom operation is being performed with the cross control key 27, but also while zoom operation is being performed with the zoom operation lever 64, and zoom operation with the zoom operation lever 64 is temporarily inactivated. This prevents conflict in the operation of the zoom operation lever 64 and the cross control key 27, and prevents the system from being damaged.

(5)

With the flowchart shown in FIG. 11, zoom operation with the zoom operation lever 64 is given priority not only while zoom operation is being performed with the zoom operation lever 64, but also while zoom operation is being performed with the cross control key 27, and zoom operation with the cross control key 27 is temporarily inactivated. This prevents conflict in the operation of the zoom operation lever 64 and the cross control key 27, and prevents the system from being damaged.

(6)

In monitor imaging mode, an electronic zoom function can be utilized since the image acquired by the imaging sensor 11 is displayed on the display unit 20 in real time. Furthermore, in monitor imaging mode, since electronic zoom operation with the cross control key 27 is activated by the body microcomputer 10, electronic zoom operation can be performed with the cross control key 27 while looking at the display unit 20, for example.

Also, electronic zoom operation cannot be used in viewfinder imaging mode since an image cannot be acquired by the imaging sensor 11. In this case, electronic zoom operation with the cross control key 27 is inactivated by the body microcomputer 10.

Thus, the convenience of the camera system 1 is enhanced because the activation and inactivation of electronic zoom operation with the cross control key 27 can be automatically switched according to the usage mode.

(7)

If zoom operation with the cross control key 27 is inactivated, a notice to the effect that zoom operation is inactivated is displayed on the display unit 20. For example, as shown in FIG. 7B, when zoom operation with the cross control key 27 is inactivated, the arrow of the zoom display part 20b is grayed out in the display. This allows the user to easily see that zoom operation with the cross control key 27 is inactivated, and makes the camera system 1 more convenient to use.

(8)

When the body microcomputer 10 has assigned an operation function other than zoom operation to the cross control key 27, the display on the display unit 20 changes according to the operation function. Therefore, the user can easily see the latest operation function to be assigned by the body microcomputer 10, and this makes the camera system 1 more convenient to use.

(9)

With this interchangeable lens unit 2, information related to whether or not it is compatible with electric zoom is included in the lens information. Since this lens information is stored in the lens microcomputer 40, it can be decided whether or not to perform zoom operation on the camera body 3 side on the basis of the lens information. This ensures interchangeability with more camera bodies 3.

### Second Embodiment

There is no problem when the autofocus imaging mode is selected as the focus imaging mode.

However, if the interchangeable lens unit 2 is compatible with electric manual focus, focusing must be performed by an operation unit on the camera body 3 side. Also, if the focus ring 67 or another such focus operation unit is mounted to the interchangeable lens unit 2, damage to the system must be prevented just as with the electric zoom discussed above.

In view of this, just as in the first embodiment, a constitution is possible in which focus operation with the cross control key 27 or the focus ring 67 is either activated or inactivated according to whether or not the interchangeable lens unit 2 is compatible with electric focus (more precisely, electric manual focus).

In the following description, those components having substantially the same function as components in the first embodiment will be numbered the same and will not be described in detail again.

1: Overall Configuration of Camera System

Just as with the assignment of zoom operation function in the first embodiment, the assignment of a manual focus operation function to the cross control key 27 is performed automatically by the body microcomputer 10. The body microcomputer 10 can assign a manual focus operation function to the cross control key 27, or can send a focus operation signal based on the operation of the cross control key 27 to the lens microcomputer 40 via the body mount 4 and the lens mount 79. When a command is sent from the lens microcomputer 40 to the focus lens group drive controller 41, the focus lens group L2 of the interchangeable lens unit 2 moves to the infinity side or to the near side.

Alternatively, the assignment of a manual focus operation function to the cross control key 27 may be activated or inactivated by pressing the cross control key 27, the menu setting button 28, and the set button 29.

When a manual focus operation function is assigned to the cross control key 27, if the left operation unit 27a of the interchangeable lens unit 2 in FIG. 3B is pressed, the body microcomputer 10 sends a focus operation signal based on this operation to the lens microcomputer 40 via the body mount 4 and the lens mount 79. When the lens microcomputer 40 sends a command to the focus lens group drive controller 41 on the basis of this focus operation signal, the focus lens group L2 of the interchangeable lens unit 2 moves to the near side.

On the other hand, if the right operation unit 27b of the cross control key 27 in FIG. 3B is pressed, the body microcomputer 10 sends a focus operation signal based on this operation to the lens microcomputer 40 via the body mount 4 and the lens mount 79. When a command is sent from the lens microcomputer 40 to the focus lens group drive controller 41 on the basis of this focus operation signal, the focus lens group L2 of the interchangeable lens unit 2 moves to the infinity side.

For example, information related to whether or not the interchangeable lens unit 2 is compatible with electric manual focus, and information related to whether or not an interchangeable lens unit 2 has a focus ring 67 (an example of a lens operation unit) for carrying out this electric manual focus, are stored as lens information in the memory 44 of the lens microcomputer 40.

When the interchangeable lens unit 2 is compatible with electric manual focus, this means that the focus lens group L2 is driven electrically in the Z axis direction. In this embodiment, since the focus lens group L2 is driven by the focus lens group drive controller 41, the interchangeable lens unit 2 can be considered to be compatible with electric manual focus. With this camera system 1, the focus lens group L2 is driven by the focus lens group drive controller 41 according to rotation of the focus ring 67.

The function whereby the focus lens group L2 is driven by the focus lens group drive controller 41 is itself a function that is originally provided for the purpose of autofocus, but it is possible to switch to this function and use it during manual focus as well. Examples of the actuator that drives the focus lens group L2 include a stepping motor, a DC motor, an electromagnetic linear motor, and an ultrasonic motor. The focus lens group drive controller 41 has one of these actuators and a drive circuit that supplies power to the actuator to control speed or position.

When this lens information is stored in the interchangeable lens unit 2, it is acquired by the body microcomputer 10 on the camera body 3 side when the interchangeable lens unit 2 is attached to the camera body 3. On the basis of the acquired lens information, the body microcomputer 10 decides whether or not the interchangeable lens unit 2 is compatible with moving picture imaging, whether or not the interchangeable lens unit 2 is compatible with electric manual focus, and whether or not a focus ring 67 is provided as a focus operation unit.

The focus speed, minimum resolution, and so forth may be stored individually depending on the performance of the ultrasonic actuator or other such focus lens group L2 actuator, and the optimal focusing performance may be set according to the combination with the camera body 3. For instance, it is possible for the camera system 1 to automatically set the frame rate during moving picture photography (30 fps, 60 fps, etc.), the recorded pixel count, and so forth.

2: Operation of Camera System

### 2.1: Focus Operation Selection Processing

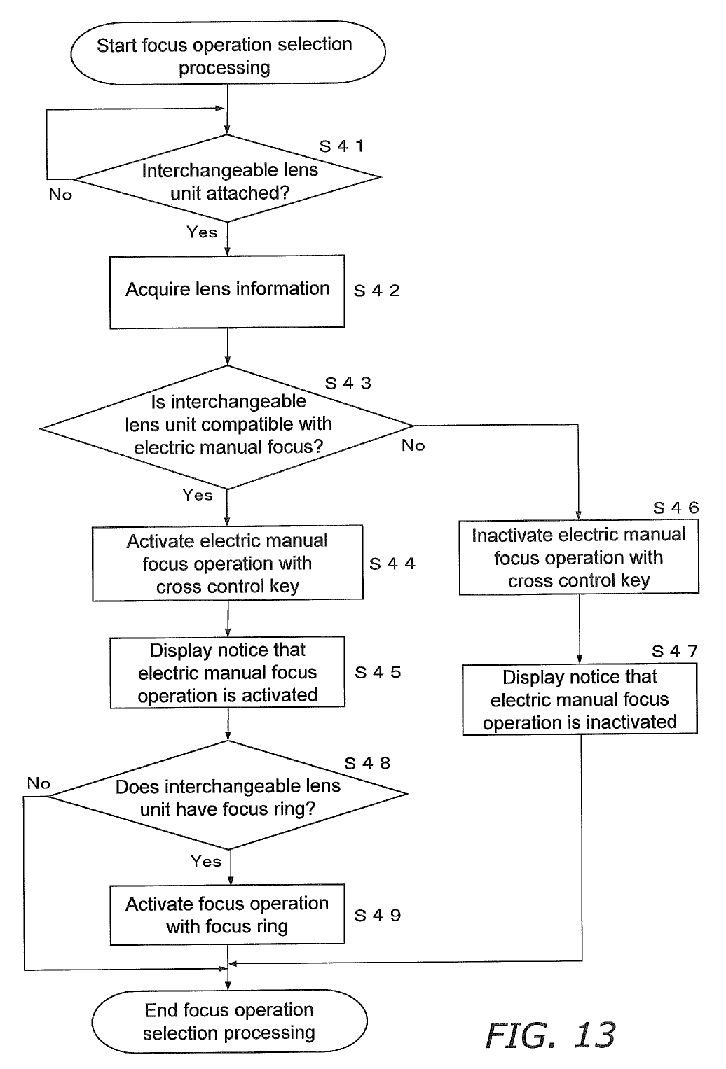

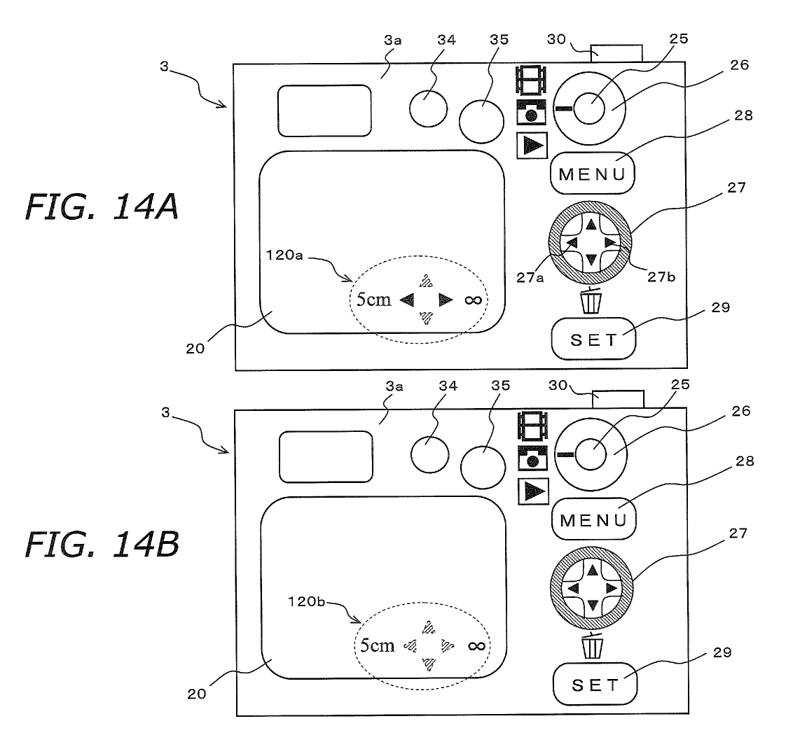

Next, focus operation selection processing when an interchangeable lens unit 2 is attached to a camera body 3 will be described through reference to FIGS. 13 and 14A and 14B.

FIG. 13 is a flowchart of focus operation selection processing. FIG. 14A is a display example when the interchangeable lens unit 2 is compatible with electric manual focus. FIG. 14B is a display example when the interchangeable lens unit 2 is not compatible with electric manual focus.

As shown in FIG. 13, first the body microcomputer 10 of the camera body 3 decides whether or not an interchangeable lens unit 2 is attached (step S41). If it is decided that an interchangeable lens unit 2 has been attached to the camera body 3, the body microcomputer 10 acquires lens information stored in the memory 44 of the interchangeable lens unit 2 (step S42). The body microcomputer 10 decides whether or not the interchangeable lens unit 2 is compatible with electric manual focus on the basis of the acquired lens information (step S43).

If the interchangeable lens unit 2 is compatible with electric manual focus, the body microcomputer 10 assigns a focus operation function to the cross control key 27 (step S44). Then, a display is made on the display unit 20 to the effect that focus operation with the cross control key 27 is activated (step S45). Here, as shown in FIG. 14A, the focus operation function is assigned to the cross control key 27 so that the focus position (subject distance) is changed to the direction of the near side (5 cm) when the left operation unit 27a of the cross control key 27 is pressed. An operation direction to the near side (5 cm) is displayed on the display unit 20, as with the display state 120a of the display unit 20. Meanwhile, the focus operation function is assigned to the cross control key 27 so that the focus position (subject distance) is changed to the direction of the infinity side (∞) when the right operation unit 27b of the cross control key 27 is pressed. An operation direction to the infinity side (∞) is displayed on the display unit 20, as with the display state 120a of the display unit 20. Displaying the display state 120a makes it easy for the user to tell whether the left and right operation units 27a and 27b of the cross control key 27 correspond to the near side or infinity side.

If the interchangeable lens unit 2 is not compatible with an electric manual focus function, the body microcomputer 10 does not assign a focus operation function to the cross control key 27 (or the assignment of the focus operation function by the body microcomputer 10 to the cross control key 27 is cancelled), and focus operation with the cross control key 27 is inactivated (step S46). At this point the body microcomputer 10 may assign another operation function to the cross control key 27.

Next, a display is made on the display unit 20 to the effect that focus operation with the cross control key 27 is inactivated (step S47). Here, as shown in FIG. 14B, because the focus operation function of the cross control key 27 is inactivated, the arrow indicating the operation directions to the near side (5 cm) and infinity side (∞) is grayed out (indicating that it cannot be used), as with the zoom display part 120b of the display unit 20. This makes it easy for the user to tell that focus operation with the cross control key 27 is impossible. After step S47, the zoom operation selection processing is ended.

In the processing of step S47, a display is made on the display unit 20 to the effect that the focus operation function is inactivated, but a display to the effect that the focus operation function is inactivated need not be made on the display unit 20.

If the interchangeable lens unit 2 is compatible with electric manual focus, after step S45 the body microcomputer 10 decides, on the basis of lens information, whether or not a focus ring 67 is installed in the interchangeable lens unit 2 (step S48). If the focus ring 67 is not installed in the interchangeable lens unit 2, the focus operation selection processing is ended.

If the focus ring is installed in the interchangeable lens unit 2, the body microcomputer 10 assigns a focus operation function to the cross control key 27, and focus operation with the cross control key 27 becomes activated (step S9).

More specifically, as discussed above, the rotation detector 68 detects that the focus ring 67 has been turned to the near side or infinity side, and this operation information is sent from the rotation detector 68 to the lens microcomputer 40. If the rotation detector 68 detects that the focus ring 67 has been turned to the infinity side, the lens microcomputer 40 controls the focus lens group drive controller 41 so that the focus lens group L2 moves to the infinity side. As a result, the focus lens group L2 is driven by the focus lens group drive controller 41 so that the subject distance changes to the infinity side.

On the other hand, if the rotation detector 68 detects that the focus ring 67 has been turned to the near side, the lens microcomputer 40 controls the focus lens group drive controller 41 so that the focus lens group L2 moves to the near side. As a result, the focus lens group L2 is driven by the focus lens group drive controller 41 so that the subject distance changes to the near side.

Information related to the object distance, which varies according to the movement of the focus lens group L2, is sent from the lens microcomputer 40, through the lens mount 79 and the body mount 4, to the body microcomputer 10.

2.2: Focus Operation Unit Selection Processing

If the interchangeable lens unit 2 is compatible with electric manual focus and has the focus ring 67, then as shown in the flowchart of FIG. 13, focus operation is possible with both the cross control key 27 and the focus ring 67.

However, depending on the imaging mode, it may be preferable for only one operation unit to be activated.

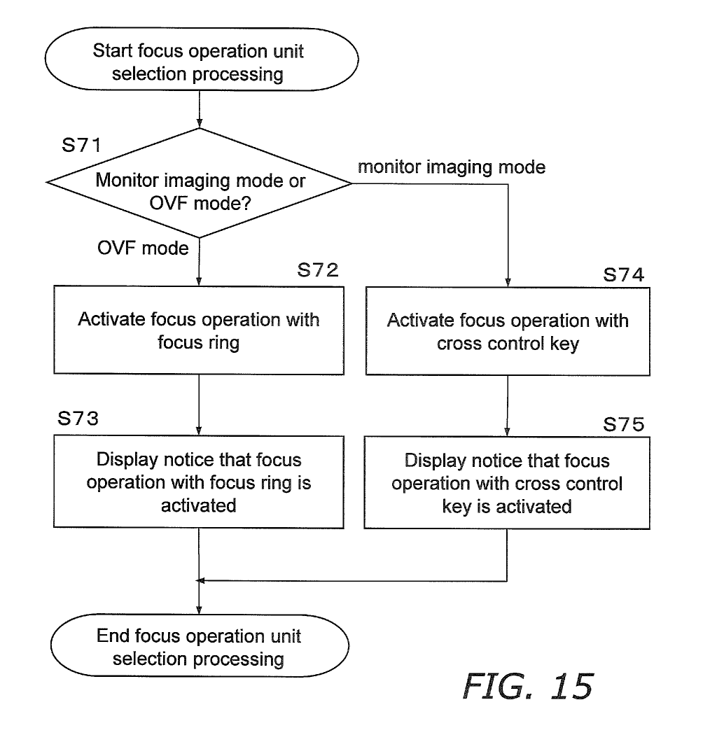

In view of this, focus operation unit selection processing, in which either the focus ring 67 or the cross control key 27 is automatically selected as the operation unit for electric manual focus according to the imaging mode, will be described through reference to FIG. 15. FIG. 15 is a flowchart of focus operation unit selection processing.

As shown in FIG. 15, the viewfinder switching button 34 provided to the rear face of the case 3a is pressed to select either viewfinder imaging mode (hereinafter also referred to as OVF mode) or monitor imaging mode (hereinafter referred to as monitor imaging mode) as the imaging mode (step S41). When the OVF mode is selected, the processing proceeds to step S12. On the other hand, if the monitor imaging mode is selected, the processing proceeds to step S44.

When the imaging mode is OVF mode, the user places his eye hear the viewfinder eyepiece window 9, and this makes the cross control key 27 of the camera body 3 harder to operate, and it is even possible that the user's face will touch the cross control key 27 and accidentally operate it. Furthermore, since an image is captured in a state in which the camera body 3 is held with the right hand and the interchangeable lens unit 2 is held with the left hand, for example, it is possible to operate the focus ring 67 on the interchangeable lens unit 2 side with the left hand while supporting the interchangeable lens unit 2 with the left hand. That is, in OVF mode, the focus ring 67 is easier to operate than the cross control key 27.

In view of this, when the OVF mode is selected, focus operation with the focus ring 67 installed in the interchangeable lens unit 2 is activated by the body microcomputer 10 (step S42). In other words, in step S42, focus operation with the cross control key 27 is temporarily inactivated by the body microcomputer 10. Then, a display is made on the display unit 20, for example, to the effect that focus operation with the focus ring 67 is activated (step S43), and processing is ended.

Meanwhile, if the imaging mode is the monitor imaging mode, the user will view the subject image on the display unit 20, so it is probably easier to operate the cross control key 27 than the focus ring 67. For example, in monitor imaging mode, the user's eyes is away from the camera body 3 during imaging, so the two hands are not on the interchangeable lens unit 2, and instead the camera body 3 is held with both hands. Therefore, it is possible, for example, to operate the cross control key 27 while holding the camera body 3 in both hands, and the cross control key 27 can be operated in a stable state.

In view of this, when the monitor imaging mode is selected as the imaging mode, focus operation with the cross control key 27 mounted on the camera body 3 is activated by the body microcomputer 10 (step S44). In other words, in step S42, focus operation with the focus ring 67 is temporarily inactivated by the body microcomputer 10. Then, a display is made on the display unit 20, for example, to the effect that focus operation with the cross control key 27 is activated (step S45), and processing is ended.

As discussed above, when focus operation is possible with both the focus ring 67 and the cross control key 27, operation of the camera can be improved by automatically selecting either the focus ring 67 or the cross control key 27 according to the imaging mode.

In the above description, the user selected either the OVF mode or the monitor imaging mode by operating the viewfinder switching button 34 providing to the rear face of the case 3a, but the method for selecting the imaging mode is not limited to this. For example, an eye detector (not shown) may be provided for detecting whether or not the user has moved his eye closer to the viewfinder eyepiece window 9, and the imaging mode may be switched on the basis of information from this eye detector. Doing this eliminates the need for the user to select the imaging mode by hand, and quick switching is possible when the user wants to switch from imaging in monitor imaging mode to the OVF mode.

Also, in monitor imaging mode, rather than inactivating operation with the focus ring 67, focus operation may be possible with both the cross control key 27 and the focus ring 67. The reason for this is that unlike in OVF mode, it is unlikely that the focus ring 67 will be accidentally operated in monitor imaging mode.

2.3: Focus Operation Unit Priory Processing

If the interchangeable lens unit 2 is compatible with electric manual focus and has the focus ring 67, then focus operation is possible with both the cross control key 27 and the focus ring 67, as shown in the flowchart of FIG. 13. Therefore, two scenarios are possible when the user adjusts the focus position: when the focus ring 67 provided to the interchangeable lens unit 2 is operated, and when the cross control key 27 provided to the camera body 3 is operated. For example, when the focus ring 67 and the cross control key 27 are operated at the same time, there is the risk of conflict in the electric manual focus operation, and that the system will be damaged.

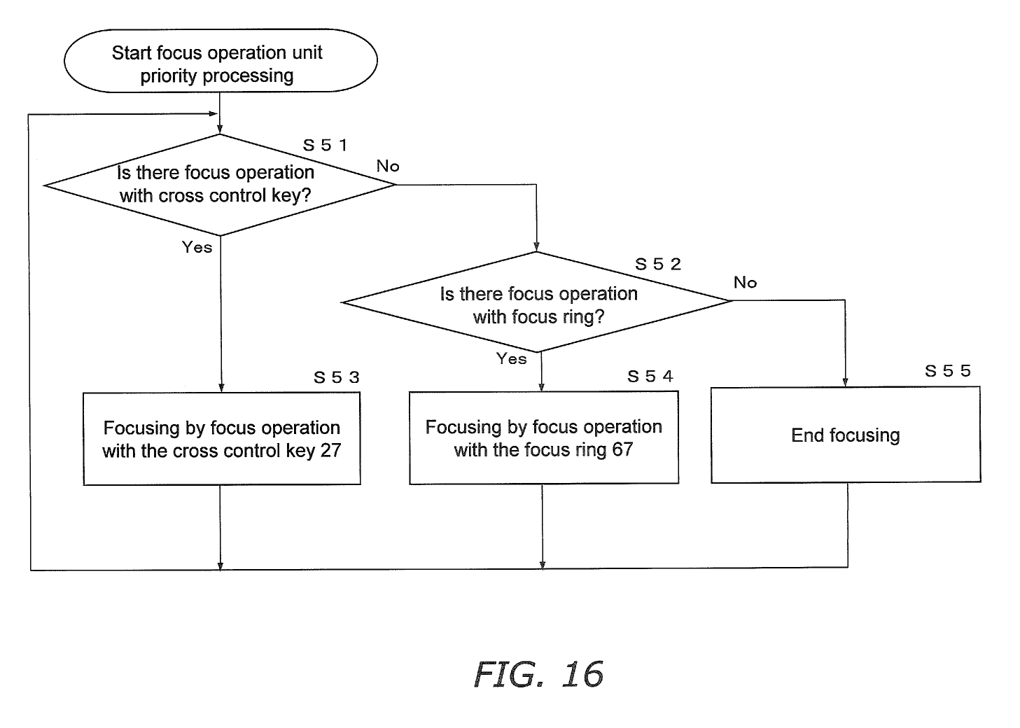

In view of this, with the camera system 1, focus operation unit priority processing is performed by the body microcomputer 10 when both the focus ring 67 and the cross control key 27 are activated, so that the system will not be damaged in the event that the focus ring 67 and the cross control key 27 are operated at the same time. This focus operation unit priority processing will be described through reference to FIG. 16. FIG. 16 is a flowchart in which the cross control key 27 provided to the camera body 3 is given priority.

As shown in FIG. 16, first the body microcomputer 10 of the camera body 3 decides whether or not focus operation is being performed with the cross control key 27 (step S51). If the body microcomputer 10 has decided that focus operation is being performed with the cross control key 27, then the focus lens group L2 is driven by the focus lens group drive controller 41 according to the focus operation with the cross control key 27, and focusing is performed (step S53). After this, the processing returns to step S51, but if the user is continuing focus operation with the cross control key 27 (such as when the cross control key 27 is held down), the processing of steps S51 and S53 is repeated at a specific period (such as at intervals of 1 ms). At this point, since only focus operation with the cross control key 27 is being monitored, even if the focus ring 67 is operated, that operation information will be ignored. In other words, while steps S51 and S52 are being repeated, focus operation with the focus ring 67 is temporarily inactivated.

If focus operation with the cross control key 27 is being continued by the user, it is also conceivable that the drive of the focus lens group L2 will be continued up to a specific focus position once the cross control key 27 is pressed. In this case, the processing moves on to step S51 after the drive of the focus lens group L2 is complete.

In step S51, if the body microcomputer 10 determines that focus operation is not being performed with the cross control key 27, then the body microcomputer 10 determines whether or not focus operation is being performed with the focus ring 67 provided to the interchangeable lens unit 2 (step S52). More specifically, the lens microcomputer 40 sends operation information about the focus ring 67 to the body microcomputer 10 at a specific period. The body microcomputer 10 determines whether or not zoom operation is being performed with the focus ring 67 on the basis of this operation information.

If the body microcomputer 10 has determined that focus operation is being performed with the focus ring 67, the focus lens group L2 is driven by the focus lens group drive controller 41 according to the focus operation of the focus ring 67, and focusing is performed (step S54).

After focus operation with the focus ring 67 is complete, the processing returns to step S51, but if the user is continuing focus operation not with the cross control key 27, but with the focus ring 67 (such as when the focus ring 67 is being held down), then the processing of steps S51, S52, and S54 is repeated at a specific period (such as at 1 ms intervals). If the cross control key 27 is pressed while steps S51, S52, and S54 are being repeated, steps S51 and S53 are repeated. In other words, even when the focus ring 67 is operated, if the cross control key 27 is operated, the operation information inputted by the focus ring 67 is ignored, and focus operation with the focus ring 67 is inactivated. That is, focus operation with the cross control key 27 is given priority.

If the user is continuing focus operation with the focus ring 67, it is also conceivable that the drive of the focus lens group L2 will be continued up to a specific focus position once the focus ring 67 is pressed. In this case, the processing moves on to step S51 after the drive of the focus lens group L2 is complete.

In step S52, if the body microcomputer 10 determines that focus operation is not being performed with the focus ring 67, that is, that neither the cross control key 27 nor the focus ring 67 is being operated, focusing is stopped (step S55). Here again, the processing of steps S51, S52, and S55 is repeated at a specific period (such as at 1 ms intervals).

As discussed above, if the drive of the focus lens group L2 is continued to a specific focus position once the cross control key 27 or the focus ring 67 to which a focus operation function has been assigned has been turned to a certain rotational angle, exceptional processing may be executed in which the processing of step S53 or step S54 is continued until the focusing is complete.

As described through reference to FIG. 16, even if the user should operate the focus ring 67 and the cross control key 27 at the same time while changing the focus position, since there is no conflict between focus operation functions on the interchangeable lens unit 2 side and the camera body 3 side, damage to the system is prevented and the focus operation function can work stably.

In particular, with the flowchart shown in FIG. 16, since whether or not focus operation is being performed with the cross control key 27 is determined prior to whether or not there is focus operation with the focus ring 67, operation of the cross control key 27 is given priority not only while focus operation is being performed with the cross control key 27, but also while focus operation is being performed with the focus ring 67.

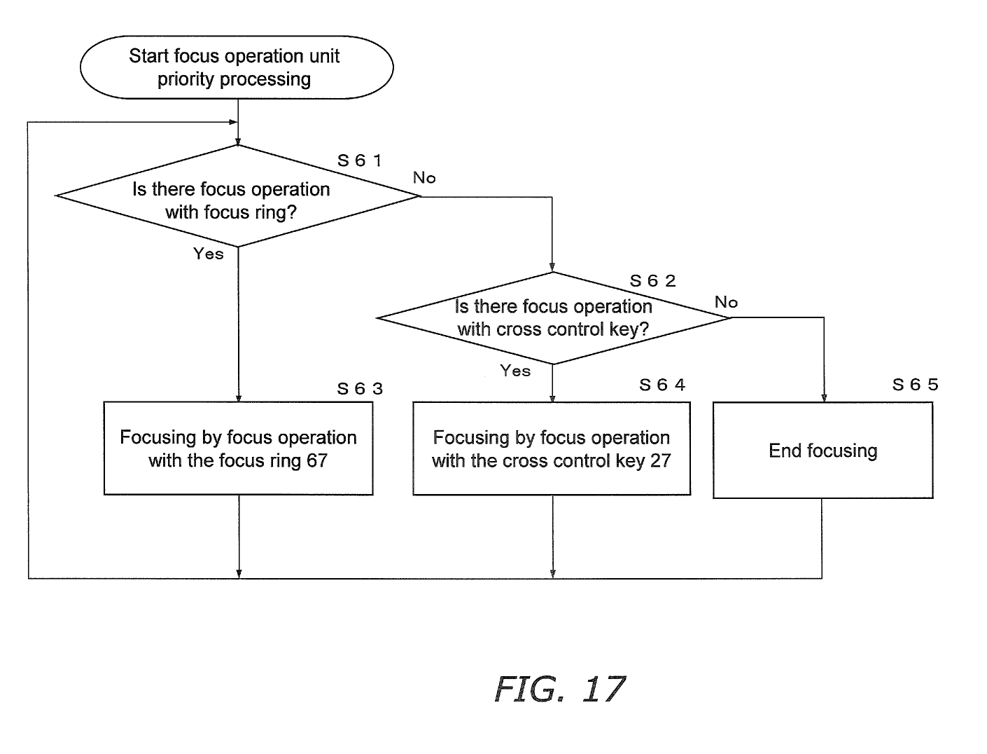

Next, a situation in which the focus ring 67 mounted to the interchangeable lens unit 2 is given priority will be described through reference to FIG. 17.

As shown in FIG. 17, first the body microcomputer 10 of the camera body 3 determines whether or not focus operation is being performed with the focus ring 67 (step S61). If the body microcomputer 10 has determined that focus operation is being performed with the focus ring 67, the focus lens group L2 is driven by the focus lens group drive controller 41 according to the focus operation of the focus ring 67, and focusing is performed (step S63).

After completion of focus operation with the focus ring 67, the processing returns to step S61, but if the user is continuing focus operation with the focus ring 67 (such as when the user continues turning the focus ring 67), then the processing of steps S61 and S63 is repeated at a specific period (such as at 1 ms intervals).

In step S61, if it is determined that focus operation is not being performed with the focus ring 67, then the body microcomputer 10 determines whether or not focus operation is being performed with the cross control key 27 mounted to the camera body 3 (step S62). If the body microcomputer 10 determines that focus operation is being performed with the cross control key 27, the focus lens group L2 is driven by the focus lens group drive controller 41 according to the focus operation with the cross control key 27, and focusing is performed (step S64). After this, the processing returns to step S61, but if the user is continuing focus operation not with the focus ring 67, but with the cross control key 27 (such as when the cross control key 27 is being held down), then the processing of steps S61, S62, and S64 is repeated at a specific period (such as at 1 ms intervals). At this point, since only focus operation with the focus ring 67 is being monitored, even if the cross control key 27 is operated, that operation information will be ignored. In other words, while steps S61 and S62 are being repeated, focus operation with the cross control key 27 is temporarily inactivated.

If focus operation with the focus ring 67 is being continued by the user, it is also conceivable that the drive of the focus lens group L2 will be continued up to a specific focus position once the focus ring 67 is pressed. In this case, the processing moves on to step S61 after the drive of the focus lens group L2 is complete.

In step S61, if the body microcomputer 10 determines that focus operation is not being performed with the cross control key 27, that is, that neither the cross control key 27 nor the focus ring 67 is being operated, then the focusing is stopped (step S65). Here again, the processing of steps S61, S62, and S65 is repeated at a specific period (such as at intervals of 1 ms).

As discussed above, if the drive of the focus lens group L2 is continued to a specific focus position once the cross control key 27 or the focus ring 67 to which a focus operation function has been assigned has been pressed, exceptional processing may be executed in which the processing of step S63 or step S64 is continued until the focusing is complete.

As described through reference to FIG. 17, even if the user should operate the focus ring 67 and the cross control key 27 at the same time while changing the focus position, since there is no conflict between focus operation functions on the interchangeable lens unit 2 side and the camera body 3 side, damage to the system is prevented and the focus operation function can work stably.

In particular, with the flowchart shown in FIG. 17, since whether or not focus operation is being performed with the focus ring 67 is determined prior to whether or not there is focus operation with the cross control key 27, operation of the focus ring 67 is given priority not only while focus operation is being performed with the focus ring 67, but also while focus operation is being performed with the cross control key 27.

As discussed above, conflict between focus operations can be prevented by giving priority to either the focus ring 67 or the cross control key 27 in focus operation. Consequently, damage to the system can be prevented, and focus operation is made more convenient.

The lens-side operation unit used for focus operation may also be a push-type operation lever as shown in FIG. 12. The working of this focus operation lever 69 will be described through reference to FIGS. 12 and 13. FIG. 12 is a simplified oblique view of a camera system 1 equipped with an interchangeable lens unit 2 in which the focus operation lever 69 has been provided as a lens-side operation unit in the first embodiment of the present invention. FIG. 13 is a block diagram of a camera system 1 equipped with an interchangeable lens unit 2 in which the focus operation lever 69 has been provided as a lens-side operation unit in the first embodiment of the present invention. In this case, the direction in which the focus operation lever 69 is operated is detected by a focus operation lever detector 70. The lens microcomputer 40 controls the drive of the focus lens group L2 via the focus lens group drive controller 41 on the basis of this detection result. As shown in FIG. 12, when the user operates the focus operation lever 69, the focus operation lever detector 70 detects from the operation direction whether the focus operation lever 69 has been operated to the infinity side (69F) or to the near side (69N), the lens microcomputer 40 controls the drive of the focus lens group L2 to the infinity side via the focus lens group drive controller 41 when the operation is to the infinity side on the basis of this detection result, and controls the drive of the focus lens group L2 to the near side via the focus lens group drive controller 41 when the operation is to the near side on the basis of this detection result. As for the rest of the constitution, FIGS. 12 and 13 are the same as FIGS. 11 and 1, respectively, so corresponding components will be numbered the same and will not be described again.

3: Features of Camera System

The features of the camera system 1 described above are compiled below.

(1)

In the field of interchangeable lens digital cameras, there are interchangeable lens units that are compatible with electric manual focus, and interchangeable lens units that are not compatible with electric manual focus. Also, an interchangeable lens unit that is compatible with electric manual focus may be equipped with a focus operation unit such as a focus ring or a focus operation lever.

However, with a conventional camera body, even if an interchangeable lens unit that is compatible with electric manual focus is mounted, since such an interchangeable lens unit was never intended to be used, there is the risk of system mismatching.

With this camera system 1, lens information is acquired from the interchangeable lens unit 2 by the body microcomputer 10. The body microcomputer 10 then determines whether or not the interchangeable lens unit 2 is compatible with electric manual focus on the basis of the acquired lens information. Based on this determination result, focus operation with the cross control key 27 is activated by the body microcomputer 10.

For example, if the interchangeable lens unit 2 is compatible with electric manual focus, focus operation with the cross control key 27 is activated by the body microcomputer 10. Accordingly, the camera body 3 will be compatible with an interchangeable lens unit 2 that is compatible with electric manual focus, so interchangeability with more interchangeable lens units 2 can be ensured.

(2)

As shown in FIG. 6, if the interchangeable lens unit 2 is not compatible with electric manual focus, then focus operation with the cross control key 27 is inactivated by the body microcomputer 10, which prevents the user from accidentally focusing.

(3)

As shown in FIG. 6, since focus operation with the focus ring 67 is activated by the body microcomputer 10, when the focus ring 67 is mounted to the interchangeable lens unit 2, for example, focus operation with the focus ring 67 will be possible. Consequently, the focus ring 67 of the interchangeable lens unit 2 can be utilized effectively. Also, interchangeability with more interchangeable lens units 2 can be ensured.

In particular, since focus operation is possible with either the cross control key 27 or the focus ring 67, the cross control key 27 and the focus ring 67 can be used as dictated by the situation, which makes the camera system 1 more convenient to use.

The constitution may also be such that the user selects either the cross control key 27 or the focus ring 67. For instance, a switch may be provided to the interchangeable lens unit 2 and/or the camera body 3. In this case, focus operation unit can be selected as desired by the user, which makes the product more convenient to use. Also, accidental operation can be prevented by inactivating operation with the focus operation unit that is not being used.

(4)

With the flowchart shown in FIG. 10, focus operation with the cross control key 27 is given priority not only while focus operation is being performed with the cross control key 27, but also while focus operation is being performed with the focus ring 67, and focus operation with the focus ring 67 is temporarily inactivated. This prevents conflict in the operation of the focus ring 67 and the cross control key 27, and prevents the system from being damaged.

(5)

With the flowchart shown in FIG. 11, focus operation with the focus ring 67 is given priority not only while focus operation is being performed with the focus ring 67, but also while focus operation is being performed with the cross control key 27, and focus operation with the cross control key 27 is temporarily inactivated. This prevents conflict in the operation of the focus ring 67 and the cross control key 27, and prevents the system from being damaged.

(6)

In viewfinder imaging mode, focus operation with the cross control key 27 is inactivated by the body microcomputer 10, and focus operation with the focus ring 67 is activated by the body microcomputer 10.

In monitor imaging mode, on the other hand, focus operation with the focus ring 67 is inactivated by the body microcomputer 10, and focus operation with the cross control key 27 is activated by the body microcomputer 10.

Thus, when focus operation is possible with both the focus ring 67 and the cross control key 27, the convenience of the system is enhanced by automatically selecting either focus ring 67 or the cross control key 27 according to the imaging mode.

(7)

If focus operation with the cross control key 27 is inactivated, a notice to the effect that focus operation is inactivated is displayed on the display unit 20. For example, as shown in FIG. 14B, when focus operation with the cross control key 27 is inactivated, the arrow of the zoom display part 20b is grayed out in the display. This allows the user to easily see that focus operation with the cross control key 27 is inactivated, and makes the system more convenient to use.

(8)

When the body microcomputer 10 has assigned an operation function that is different from focus operation to the cross control key 27, what is displayed on the display unit 20 changes according to the operation function. Therefore, it is easier for the user to see that a new operation function has been assigned by the body microcomputer 10, which makes the camera system 1 more convenient to use.

(9)

With this interchangeable lens unit 2, lens information includes information related to whether or not the unit is compatible with electric manual focus. Since this lens information is stored in the lens microcomputer 40, it can be determined whether or not to perform focus operation on the camera body 3 on the basis of this lens information. This makes it easier to ensure interchangeability with the camera body 3.

### Third Embodiment

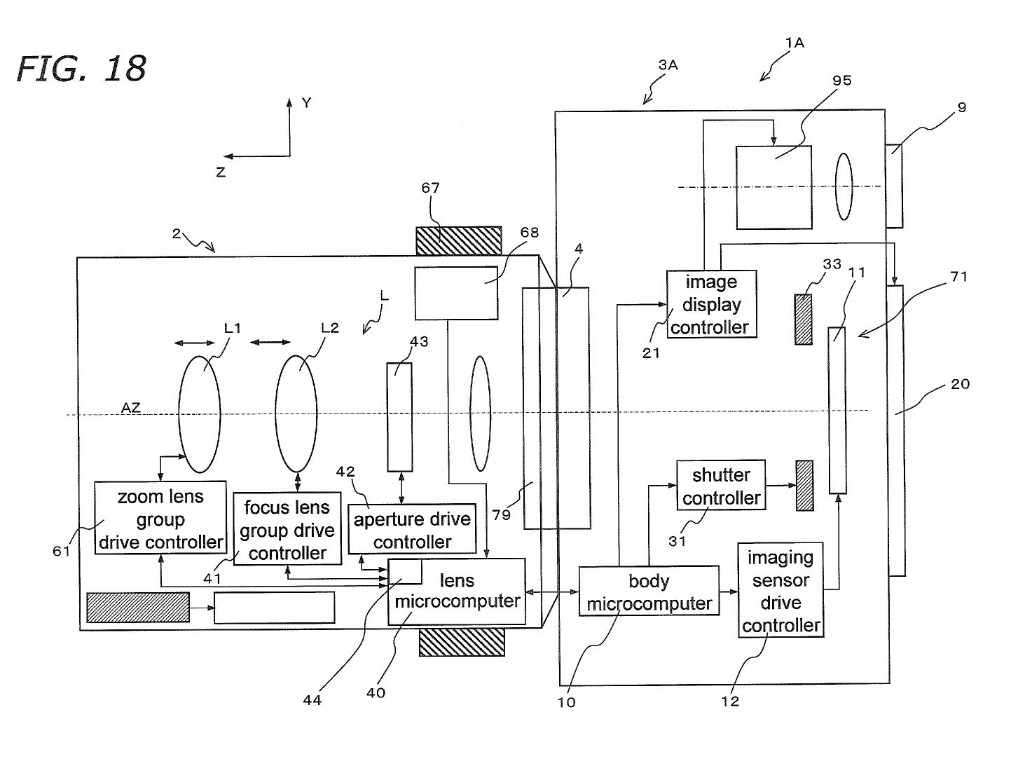

The quick return mirror 23 was used in the first and second embodiments, but if focusing is possible by contrast detection method, the quick return mirror 23 can be eliminated. A camera system 1A according to a second embodiment will be described through reference to FIG. 18. FIG. 18 is a block diagram of the configuration of the camera system 1A. Those components that have substantially the same function as the components shown in FIG. 1 will be numbered the same and will not be described in detail again.

1: Overall Configuration of Camera System

In FIG. 18, the camera system 1A is a digital single lens reflex camera system with an interchangeable lens, and mainly comprises a camera body 3A having the main functions of the camera system 1A, and an interchangeable lens unit 2 that is removably mounted to the camera body 3A. The interchangeable lens unit 2 is mounted via a lens mount 79 provided at the rearmost part, to a body mount 4 provided to the front face of the camera main body 3A.

The camera body 3A shown in FIG. 18 differs from the camera body 3 shown in FIG. 1 in that the quick return mirror 23 for guiding incident light from the imaging unit 71 to the viewfinder optical system 22 and focus point detection unit 5 is omitted. Along with the quick return mirror 23, also omitted are the viewfinder screen 6, the pentaprism 7, the eyepiece lens 8, and the focus point detection unit 5.

In their place is provided an electronic viewfinder 95, such as a liquid crystal viewfinder. An image signal recorded to the image recorder 18 or the buffer memory 16 can be displayed as a visible image on this electronic viewfinder 95 on the basis of a command from the image display controller 21. Consequently, even though there is no quick return mirror 23, an optical image of the subject formed by the optical system L can be viewed through the viewfinder eyepiece window 9.

Again with this camera system 1A, just as with the above-mentioned camera system 1, conflict in zoom operation or focus operation can be prevented, and damage to the system can also be prevented.

Furthermore, in this case, the camera body 3A can be made thinner in the optical axis direction AZ of the camera body 3A because the viewfinder optical system 22 and the quick return mirror 23 are eliminated. Further, since the distance (lens back) from the imaging sensor 11 to the rearmost lens of the interchangeable lens unit 2 can be shortened, it is possible to make the interchangeable lens unit 2 more compact.

Also, when the interchangeable lens unit 2 is compatible with moving picture imaging, with the camera body 3A in FIG. 18, a contrast method based on image data produced by the imaging sensor 11 can always be used as the focus point detection method. This means that more accurate focusing is possible. Furthermore, since there is no need to open and close the quick return mirror 23, focusing can be performed faster and more quietly, so this can be applied not only to still picture imaging, but also to moving picture imaging.

### Other Embodiments

Embodiments of the present invention are not limited to the embodiments given above, and various modifications and changes are possible without departing from the gist of the invention.

Those components having substantially the same function as components in the above embodiments will be numbered the same and will not be described in detail again.

(1)

In the above embodiments, the various setting menus for moving picture imaging can be set using the display unit on the basis of whether or not moving picture imaging is possible with the interchangeable lens unit 2.

(2)

An image blur correction unit may be provided to the interchangeable lens unit 2, to the camera body 3, or to both. If to both, the camera system may be such that either image blur correction unit can be selected.

(3)

In the above embodiments, the exposure time of the imaging sensor was controlled by operating the shutter, but the present invention is not limited to this, and the exposure time of the imaging sensor may instead be controlled by an electronic shutter or the like.

(4)

In the above embodiments, the lens information includes information about whether or not there is compatibility with moving picture imaging. However, whether or not there is compatibility with moving picture imaging may be decided from whether or not the drive system of the focus lens group, or the focus lens group drive controller 41 or the like, is compatible with contrast detection. As to the drive method for the focus lens group, it is also possible to decide whether or not the method involves directly driving the focus lens group using a stepping motor or a linear actuator (either electromagnetic or piezoelectric).

(5)

In the above embodiments, the interchangeable lens unit 2 is compatible with moving picture imaging, but there may also be situations in which the interchangeable lens unit is not compatible with moving picture imaging.

(6)

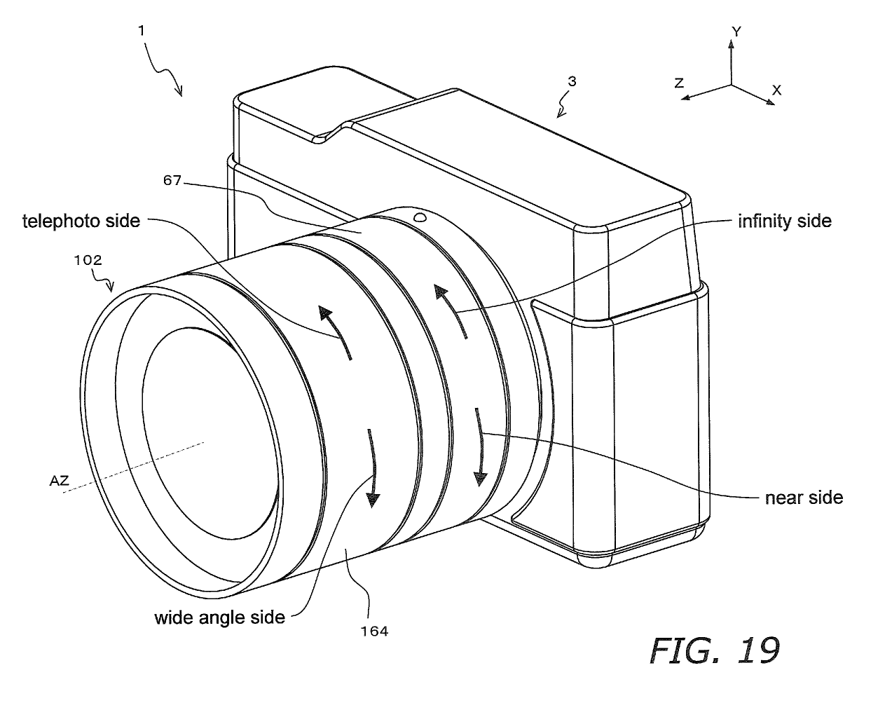

In the first to third embodiments above, the zoom operation unit for zoom operation was a lever type such as the zoom operation lever 64, but as shown in FIG. 19, the zoom operation lever 64 may instead be a zoom ring 164 that is similar to the focus ring 67.

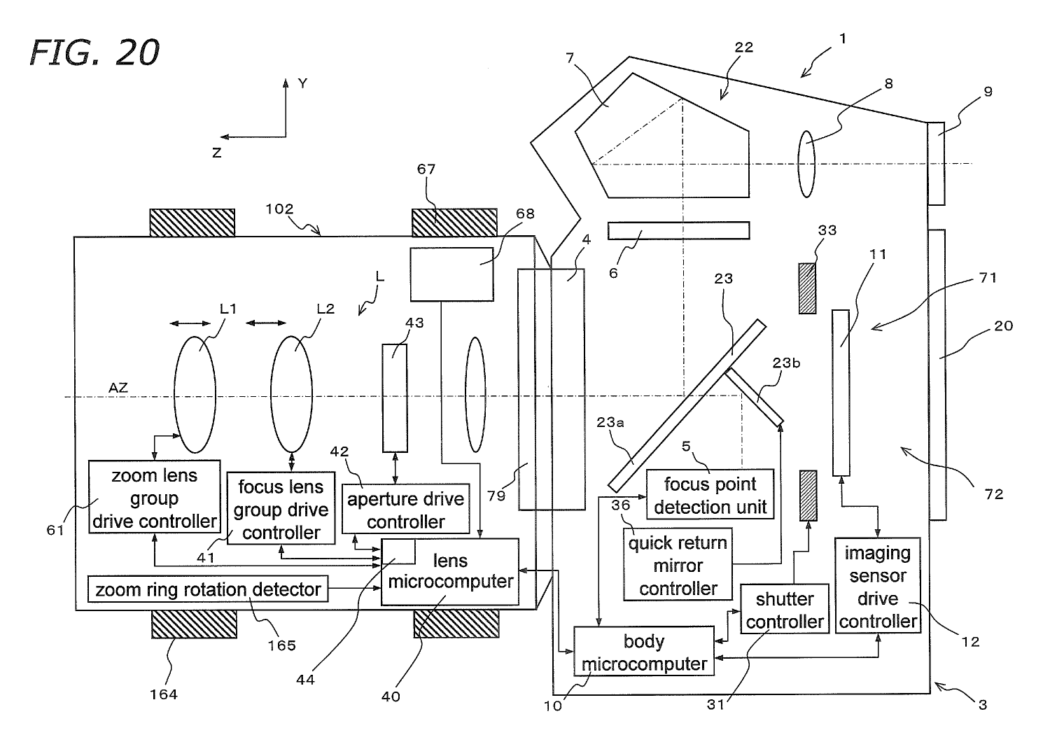

With this interchangeable lens unit 102, as shown in FIG. 20, the rotational direction and rotational angle of the focus ring 164 are detected by a zoom ring rotation detector 165. The detection result from the zoom ring rotation detector 165 is outputted to the lens microcomputer 40. The lens microcomputer 40 sends a drive signal to the zoom lens group drive controller 61 on the basis of this detection result. The zoom lens group drive controller 61 drives the zoom lens group L1 on the basis of this drive signal.

For example, if the user turns the focus ring 164 to the telephoto side, the zoom lens group drive controller 61 drives the zoom lens group L1 so that the zoom lens group L1 moves to the telephoto side. If the user turns the focus ring 164 to the wide angle side, the zoom lens group drive controller 61 drives the zoom lens group L1 so that the zoom lens group L1 moves to the wide angle side.

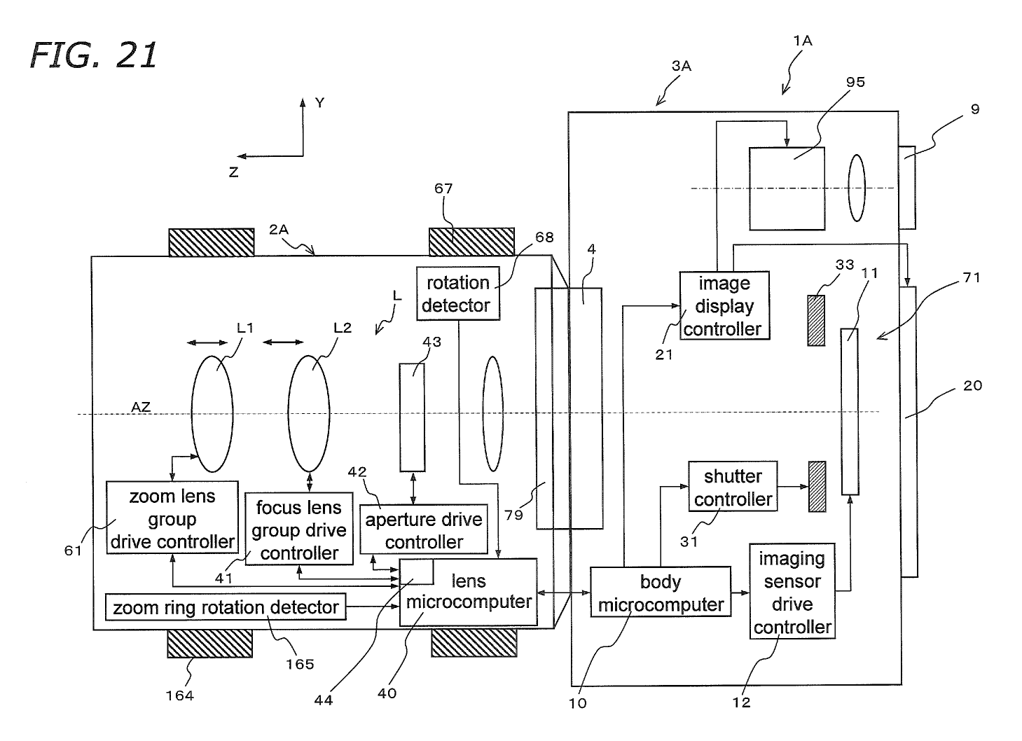

When the focus ring 164 is employed with the camera system 1A of the third embodiment, the constitution is as shown in FIG. 21.

(7)

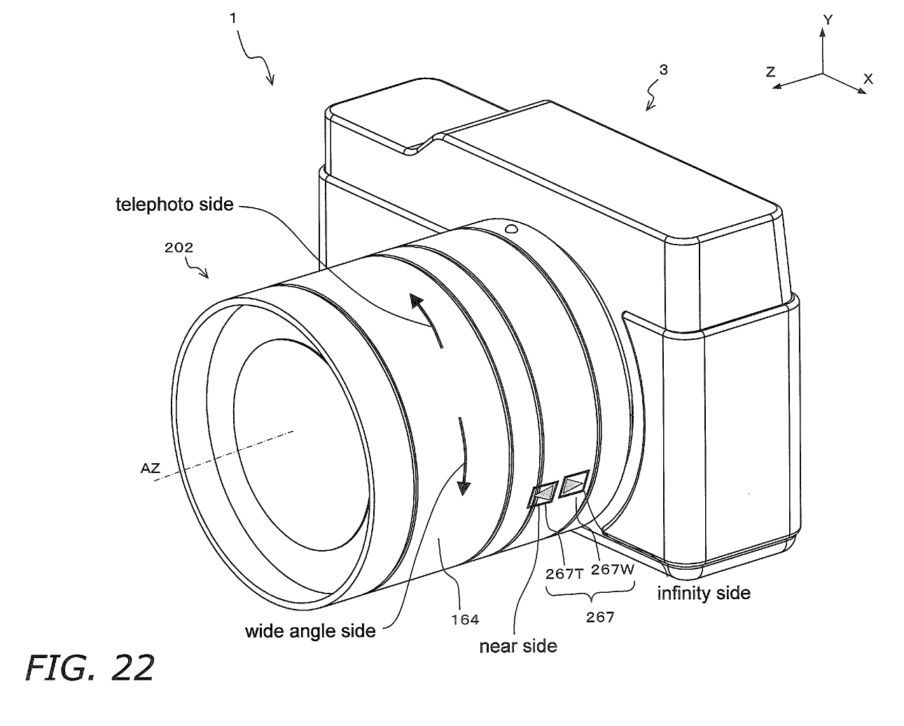

In the first to third embodiments above, the focus operation unit for focus operation was a ring-shaped member such as the focus ring 67, but as shown in FIG. 22, the focus ring 67 may instead be a focus operation lever 267 that is similar to the zoom operation lever 64. The focus operation lever 267 can be operated in two directions: to the near side (267T) and to the infinity side (267W).

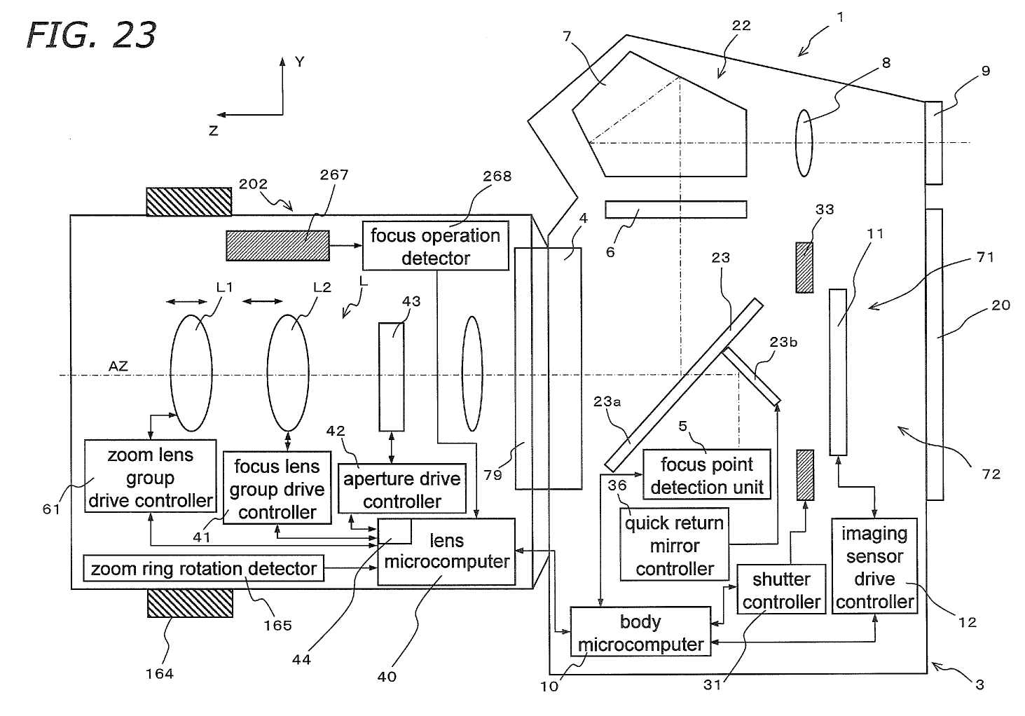

With this interchangeable lens unit 202, as shown in FIG. 23, operation of the focus operation lever 267 is detected by a focus operation detector 268. The detection result from the focus operation detector 268 is outputted to the lens microcomputer 40. The lens microcomputer 40 sends a drive signal to the focus lens group drive controller 41 on the basis of this detection result. The focus lens group drive controller 41 drives the focus lens group L2 on the basis of this drive signal.

For example, if the user moves the focus operation detector 268 to the near side, the focus lens group drive controller 41 drives the focus lens group L2 so that the focus lens group L2 moves to the near side. If the user moves the focus operation lever 267 to the infinity side, the focus lens group drive controller 41 drives the focus lens group L2 so that the focus lens group L2 moves to the infinity side.

(8)

In the first to third embodiments above, a focus ring 67 for electric manual focus is provided to the interchangeable lens unit 2, but this focus ring 67 may constitute part of a mechanical manual focus operation unit. In this case, electric manual focus or mechanical manual focus can be operated with the focus ring 67.

(9)

In the first embodiment, the constitution may be such that the user selects either the cross control key 27 or the focus ring 67. For example, a switch may be provided to the interchangeable lens unit 2 and/or the camera body 3. In this case, the user can select the focus operation unit according to personal preference, which makes the system more convenient to use. Also, accidental operation can be prevented by inactivating the focus operation unit that is not being used.

(10)

In the second embodiment, the constitution may be such that the user selects either the cross control key 27 or the focus ring 67. For example, a switch may be provided to the interchangeable lens unit 2 and/or the camera body 3. In this case, the user can select the focus operation unit according to personal preference, which makes the system more convenient to use. Also, accidental operation can be prevented by inactivating the focus operation unit that is not being used.

(11)

In the above embodiments, a zoom operation function or focus operation function is assigned to the cross control key 27, but a zoom operation function or focus operation function may instead be assigned to another operation unit.

### INDUSTRIAL APPLICABILITY

With the camera body and camera system according to the present invention, interchangeability with more interchangeable lens units can be ensured, which is advantageous for interchangeable lens imaging devices.

1. A camera body to which an interchangeable lens unit having an optical system for forming an optical image of a subject can be mounted, the camera body comprising:
a body operation interface with which the user can input operation information;
an information acquisition section with which lens information related to the interchangeable lens unit can be acquired from the interchangeable lens unit;
a decision section configured to decide whether or not the optical system can be driven electrically in the optical axis direction, on the basis of the lens information; and
an operation setting section configured to activates a lens drive operation for driving the optical system at the body operation interface, on the basis of the decision result of the decision section.

2. The camera body according to claim 1, wherein
the operation setting section activates the lens drive operation at the body operation interface when the optical system can be electrically driven in the optical axis direction.

3. The camera body according to claim 1, wherein
the operation setting section inactivates the lens drive operation at the body operation interface when the optical system cannot be electrically driven in the optical axis direction.

4. The camera body according to claim 1, wherein
the operation setting section assigns to the body operation interface an operation function that is different from the lens drive operation when the optical system cannot be electrically driven in the optical axis direction.

5. The camera body according to claim 1, wherein
the body operation interface has an electric zoom operation unit that allows electric zoom operation for changing the focal length of the optical system,
the decision section decides whether or not the interchangeable lens unit is compatible with electric zoom in which the focal length is changed electrically, on the basis of the lens information, and
the operation setting section activates the electric zoom operation at the electric zoom operation unit when it is decided by the decision section that the interchangeable lens unit is compatible with electric zoom.

6. The camera body according to claim 5, wherein
the operation setting section inactivates the electric zoom operation at the electric zoom operation unit when it is decided by the decision section that the interchangeable lens unit is not compatible with the electric zoom.

7. The camera body according to claim 1, wherein
the body operation interface has a focus operation unit that allows focus operation for changing the subject distance at which the state of being in focus is achieved,
the decision section is configured to decides whether or not the interchangeable lens unit is compatible with electric focus on the basis of the lens information, and
the operation setting section activates the focus operation at the focus operation unit when it is decided by the decision section that the interchangeable lens unit is compatible with the electric focus.

8. The camera body according to claim 7, wherein
the operation setting section inactivates the focus operation at the focus operation unit when it is decided by the decision section that the interchangeable lens unit is not compatible with the electric focus.

9. The camera body according to claim 7, further comprising:
an image acquisition section configured to convert an optical image of the subject into an electrical signal and acquiring an image of the subject;
a viewfinder near to which the user moves an eye to observe the subject; and
a display unit configured to display the image so that the user can observe the subject without moving an eye near to the viewfinder, wherein
the operation setting section inactivates operation at the body operation interface in a first imaging mode in which the subject is observed through the viewfinder, and
the operation setting section activates operation at the body operation interface in a second imaging mode in which the subject is observed via the display unit.

10. The camera body according to claim 1 to 9, wherein
the lens information includes information related to whether or not a lens operation unit with which drive of the optical system can be controlled is installed in the interchangeable lens unit,
the decision section is configured to decides whether or not the lens operation unit is installed in the interchangeable lens unit on the basis of the lens information, and
the operation setting section is configured to activates the operation of the lens operation unit on the basis of the decision result of the decision section.

11. The camera body according to claim 10, wherein
the operation setting section inactivates operation at the body operation interface while the lens operation unit is being operated.

12. The camera body according to claim 10, wherein
the operation setting section inactivates operation at the lens operation unit while the body operation interface is being operated.

13. The camera body according to claim 10, further comprising:
an image acquisition section configured to convert an optical image of the subject into an electrical signal and acquiring an image of the subject;
a display unit configured to display the image; and
an electronic zoom section configured to enlarge part of the image and display the enlarged part of the image on the display unit, wherein
the operation setting section is configured to assigns to the body operation interface an electronic zoom operation function for changing the enlargement ratio at the electronic zoom section.

14. The camera body according to claim 13, wherein
the operation setting section activates the electronic zoom operation at the body operation interface when an image acquired by the image acquisition section is displayed on the display unit in real time.

15. The camera body according to claim 13, wherein
the operation setting section inactivates the electronic zoom operation at the body operation interface when an image acquired by the image acquisition section is not displayed on the display unit in real time.

16. The camera body according to claim 13, further comprising:
a display controller configured to control the display unit, wherein
the display controller controls the display unit so that a notice to the effect that operation of the drive of the optical system is inactivated is displayed on the display unit when the operation of the optical system drive at the body operation interface has been inactivated by the operation setting section.

17. The camera body according to claim 16, wherein
the display controller changes the display content on the display unit according to the operation function when the operation setting section assigns to the body operation interface an operation function that is different from the optical system drive function.

18. An interchangeable lens unit, comprising:
an optical system; and
a memory unit configured to store lens information including information related to whether or not the optical system can be electrically driven in an optical axis direction.

19. The interchangeable lens unit according to claim 18, wherein
the lens information includes information related to whether or not a lens operation unit is installed for the optical system drive operation.

20. A camera system comprising:
an optical system configured to form an optical image of a subject;
a body operation interface with which the user can input operation information;
an information acquisition section with which lens information related to the interchangeable lens unit can be acquired from the interchangeable lens unit
a decision section configured to decide whether or not the optical system can be driven electrically in the optical axis direction, on the basis of the lens information; and
an operation setting section configured to activate a lens drive operation for driving the optical system at the body operation interface, on the basis of the decision result of the decision section.
